(19) United States
(12) Patent Application Publication
(10) Pub. No.: US 2008/0153931 A1
(43) Pub. Date: Jun. 26, 2008

(54) Hyperbranched Polymers for Use as Demulsifiers for Cracking Crude Oil Emulsions

(75) Inventors: Bernd Bruchmann, Friensheim (DE); Karl-Heinz Buchner, Altlussheim (DE); Marcus Guzmann, Muhlhausen (DE); Gregor Brodt, Heppenheim (DE); Stefan Frenzel, Mannheim (DE)

Correspondence Address: CONNOLLY BOVE LODGE & HUTZ, LLP, P O BOX 2207, WILMINGTON, DE, 19899, US

(73) Assignee: BASF Aktiengesellschaft, Ludwigshafen (DE)

(21) Appl. No.: 11/815,785

(22) PCT Filed: Feb. 2, 2006
(86) PCT No.: PCT/EP2006/050610

§ 371 Date: Aug. 8, 2007

(30) Foreign Application Priority Data
Feb. 9, 2005 (DE) 10 2005 006 030.7

(51) Int. Cl. C10G 33/04; B01D 17/05

(52) U.S. Cl. 516/185

(57) ABSTRACT

The invention relates to the use of nondendrimeric, highly functional, hyperbranched polymers as demulsifiers for breaking crude oil emulsions. The hyperbranched polymers are preferably hyperbranched polycarbonates, hyperbranched polyesters, hyperbranched polyethers, hyperbranched polyurethanes, hyperbranched polyureapolyurethanes, hyperbranched polyureas, hyperbranched polyamides, hyperbranched polyetheramines and hyperbranched polyesteramides which are functional groups selected from the group consisting of —OC(O)OR, —COOH, —COOR, —CONHR, —CONH₂, —OH, —SH, —NH₂, —NHR, —NR₂, —SO₃H, —SO₃R, —NHCOOR, —NHCONH₂ and —NHCONHR, where R is an optionally substituted alkyl or aryl radical.

The invention relates to the use of hyperbranched polymers as demulsifiers for breaking crude oil emulsions.

Mineral oil is as a rule a relatively stable water-in-oil emulsion. It may comprise up to 90% by weight of water, depending on age and deposit. Crude oil emulsions differ in their composition from deposit to deposit. In addition to water, the crude oil emulsion generally also comprises from 0.1 to 25% by weight of salts and solids. Water, salts and solids have to be removed before the crude oil emulsion can be transported and can be processed as crude oil in the refinery. The crude oil itself is a heterogeneous mixture and comprises in particular natural emulsifiers, such as naphthenic acids, heterocyclic nitrogen compounds and oxidized hydrocarbons, and furthermore mineral oil colloids, such as asphaltenes and resins, inorganic salts, such as iron sulfides, iron oxides, clays and ores, sodium chloride and potassium chloride.

The breaking of crude oil emulsion is carried out for economic and technical reasons, in order firstly to avoid the uneconomical transport of water, to prevent or to at least minimize corrosion problems, and in order to reduce the use of energy for the transport pumps.

The breaking of the crude oil emulsion is thus a substantial process step in mineral oil production. The water which is comprised in the crude oil and is emulsified in particular by natural emulsifiers, such as naphthenic acids, forms a stable emulsion. This occurs because the emulsifiers reduce the interfacial tension between water phase and oil phase and thus stabilize the emulsion. By adding emulsion breakers (demulsifiers), i.e. interface-active substances, which enter the oil-water interface and displace the natural emulsifiers there, coalescence of the emulsified water droplets can be achieved, which finally leads to phase separation.

EP-A 0 264 841 describes the use of linear copolymers of hydrophobic acrylic or methacrylic esters and hydrophilic ethylenically unsaturated monomers as mineral oil emulsion breakers.

EP-A 0 499 068 describes the preparation of reaction products of vinylic monomers and alcohol alkoxylates or phenol alkoxylates and the use thereof as demulsifiers for crude oil emulsions.

U.S. Pat. No. 5,460,750 describes reaction products of phenol resins and alkylene oxides as emulsion breakers for crude oil emulsions.

EP-A 0 541 018 describes emulsion breakers prepared from polyethylenimines having a weight average molecular weight of up to 35 000 g/mol and ethylene oxide and propylene oxide, an alkylphenolformaldehyde resin additionally being used as a second active component.

EP-A 0 784 645 describes the preparation of alkoxylates of polyamines, especially of polyethylenimines and polyvinylamines, and the use thereof as crude oil emulsion breakers.

EP-A 0 267 517 discloses branched polyaminoesters as demulsifiers. The branched polyaminoesters are obtained by reacting alkoxylated primary amines with triols and dicarboxylic acids.

Dendrimeric polymers are furthermore described as demulsifiers for crude oil.

U.S. Pat. No. 4,507,466 and U.S. Pat. No. 4,857,599 disclose dendrimeric polyamidoamines. U.S. Pat. No. 4,568,737 discloses dendrimeric polyamidoamines and hybrid dendrimers of polyamidoamines, polyesters and polyethers, and the use thereof as demulsifiers for crude oil. The preparation of dendrimer is very complicated (see below) and these products are therefore very expensive and can scarcely be used economically in industrial applications.

DE 103 29 723 describes the preparation of alkoxylated, dendrimeric polyesters and the use thereof as biodegradable emulsion breakers. The dendrimeric polyesters used are based on a polyfunctional alcohol as the central molecule and a carboxylic acid which has at least two hydroxyl groups as a synthesis component. Synthesis components which have both an acid function and at least two hydroxyl functions, so-called AB₂ building blocks, are comparatively rare and therefore expensive. furthermore, the synthesis of dendrimers is complicated and expensive (see below).

It is an object of the present invention to provide further demulsifiers for breaking crude oil emulsions. These should be simple and economical to prepare.

The object is achieved by the use of nondendrimeric, highly functional, hyperbranched polymers as demulsifiers for breaking crude oil emulsions.

Dendrimers, arborols, starburst polymers or hyperbranched polymers are designations for polymers which are distinguished by a highly branched structure and a high functionality. Dendrimers are molecularly uniform macromolecules having a highly symmetrical structure. Dendrimers can be prepared, starting from a central molecule, by controlled, stepwise linkage of in each case two or more difunctional or polyfunctional monomer with each monomers which is already bound. The number of monomer terminal groups (and hence of linkages) is multiplied with each linkage step by a factor of 2 or more, and synthesized, monodisperse polymers having tree-like structures, ideally spherical, whose branches in each case comprise exactly the same number of monomer units are obtained generation by generation. Owing to this perfect structure, the polymer properties are advantageous; for example, a surprisingly low viscosity and a high reactivity owing to the large number of functional groups on the surface of the sphere are observed. However, the preparation of the monodisperse dendrimers is complicated by the fact that, in each linkage step, protective groups have to be introduced and removed again, and intensive purification operations are required before the beginning of each new growth stage, for which reason dendrimers are usually prepared only on a laboratory scale.

The special reaction conditions which are required in order to prepare dendrimers are explained below by way of example for the preparation of dendrimeric polyurethanes. In order to obtain exactly defined structures in the preparation of the dendrimeric polyurethanes, it is necessary to add in each case at least so many monomers that each free functional group of the polymer can react. At the beginning of the reaction, at least one polyfunctional molecule, which is referred to as an initiator molecule or initiator nucleus, is initially taken, with the functional groups of this one molecule each undergoing an addition reaction with a molecule which is reactive with this functional group. Thereafter, the unconverted monomers are separated off and the intermediate is purified. Thereafter, one polyfunctional monomer each is subjected to an addition reaction again with each free functional group of the intermediate, after which the excess monomers are separated off and purification is carried out, and this procedure is continued until the desired molecular weight is reached or, for steric reasons, an addition reaction of further monomers is no longer possible. The individual intermediate stages are also referred to as generations, the intermediate formed by addition reaction of monomers with the initiator molecule being referred to as the first generation, the next intermediate as the second generation, and so on. Because of the different reactivity of the functional groups of the monomers used, it is ensured that in each case the most reactive functional groups react with the terminal groups of the dendrimer chains and the less reactive functional groups of the monomers form the functional terminal groups of the next generation of the dendrimeric polyurethanes.

Thus, the preparation of the dendrimeric polyurethanes can be effected by reacting 1 mol of a diisocyanate with two moles of an aminodiol to give the first generation of the dendrimeric polyurethane. The temperature in the reaction should be as low as possible, preferably in the range from −10 to 30° C. Virtually complete suppression of the urethane formation reaction takes place in this temperature range, and the NCO groups of the isocyanate react exclusively with the amino group of the aminodiol. In the next reaction step, the free hydroxyl groups of the added aminodiol react at an elevated temperature, preferably in the range from 30 to 80° C., selectively with the reactive NCO group of the isocyanate added. The resulting dendrimeric polyurethane of the second generation has, as functional terminal groups, the inert NCO groups of the isocyanate added. These in turn, as in the preparation of the first generation of the dendrimeric polyurethane, react at a lower temperature with the aminodiol, and so on. The reaction can be carried out in the absence of a solvent or in solvents with or without a urethane formation catalyst. If required, excess monomers can be separated off and/or a purification step can be effected between the reaction stages.

In this way, dendrimeric polyurethanes which double their functionality with each generation can be produced.

In an analogous manner, trifunctional and higher-functional isocyanates and compounds having four or more functional groups reactive toward isocyanates can also be reacted.

The generation-by-generation synthesis described is required in order to produce dendrimeric structures having a completely regular composition.

In contrast, hyperbranched polymers are both molecularly and structurally nonuniform. They are obtained by a synthesis which does not take place generation by generation. It is therefore also unnecessary to isolate and to purify intermediates. Hyperbranched polymers can be obtained by simple mixing of the components required for the synthesis, and reaction thereof in a so-called one-pot reaction. Hyperbranched polymers may have dendrimeric substructures. In addition, however, they also have linear polymer chains and unequal polymer branches. So-called ABₓ monomers are particularly suitable for the synthesis of the hyperbranched polymers. These have two different functional groups A and B in a molecule, which can undergo an intermolecular reaction with one another with formation of a link. The functional group A is comprised only once per molecule and the functional group B twice or more. The reaction of said ABₓ monomers with one another results in the formation of uncrosslinked polymers having regularly arranged branching points. The polymers have virtually exclusively B groups at the chain ends.

Furthermore, hyperbranched polymers can be prepared via the Aₓ+B_{y} synthesis route. Aₓ and B_{y} therein are two different monomers having the functional groups A and B and the indices x and y for the number of functional groups per monomer. In the case of the Aₓ+B_{y} synthesis, presented here by way of example for an A₂+B₃ synthesis, a difunctional monomer A₂ is reacted with a trifunctional monomer B₃. A 1:1 adduct of A and B having on average one functional group A and two functional groups B first forms and can then likewise react to give a hyperbranched polymer. The hyperbranched polymers thus obtained also have predominantly B groups as terminal groups.

The feature “hyperbranched” in relation to the polymers means, in the context of the invention, that the degree of branching DB of the relevant substances, which is defined as

$$DB ( \% ) = \frac{T + Z}{T + Z + L} \times 100 ,$$

where T is the average number of terminally bonded monomer units, Z is the average number of branch-forming monomer units and L is the average number of linearly bonded monomer units in the macromolecules of the respective substances, is from 10 to 95%, preferably from 25-90% and particularly preferably from 30 to 80%.

The nondendrimeric hyperbranched polymers used according to the invention differ from the dendrimeric polymers in the degree of branching thus defined. In relation to the present invention, “dendrimers” are the polymers when their degree of branching DB is 99.9-100%. Thus, a dendrimer has the maximum possible number of branching points which can be achieved only by a highly symmetrical structure. For the definition of the “degree of branching”, also see H. Frey et al., Acta Polym. 1997, 48, 30.

In the context of this invention, hyperbranched polymers are understood as meaning substantially uncrosslinked macromolecules which are both structurally and molecularly nonuniform. Starting from a central molecule, they can be synthesized analogously to dendrimers but with nonuniform chain length of the branches. However, they may also be linear with functional side branches or, as a combination of the two extremes, may have linear and branched molecular moieties. For the definition of dendrimeric and hyperbranched polymers, also see P. J. Flory, J. Am. Chem. Soc. 1952, 74, 2718 and H. Frey et al., Chem. Eur. J. 2000, 6, No. 14, 2499.

According to the invention, hyperbranched polymers, i.e. nondendrimeric polymers in the sense of the above definition, i.e. molecularly and structurally nonuniform polymers, are used as demulsifiers.

Hyperbranched polymers having functional groups can be synthesized in a manner known in principle with the use of ABₓ, preferably AB₂ or AB₃, monomers. The ABₓ monomers can firstly be incorporated completely in the form of branches into the hyperbranched polymer, they can be incorporated as terminal groups, i.e. still have x free B groups, and they can be incorporated as linear groups having (x−1) free B groups. Depending on the degree of polymerization, the hyperbranched polymers obtained have a larger or smaller number of B groups, either as terminal groups or as side groups. Further information on hyperbranched polymers and the synthesis thereof are to be found, for example, in J. M. S.—Rev. Macromol. Chem. Phys., C37(3), 555-579 (1997) and the literature cited there.

The choice of hyperbranched polymers as demulsifiers for crude oil emulsions is in principle not limited to a certain polymer class. Hyperbranched polymers suitable as demulsifiers are hyperbranched polycarbonates, hyperbranched polyesters, hyperbranched polyethers, hyperbranched polyurethanes, hyperbranched polyureapolyurethanes, hyperbranched polyureas, hyperbranched polyamides, hyperbranched polyetheramines and hyperbranched polyesteramides. Hyperbranched polymers preferred as demulsifiers are hyperbranched polycarbonates, hyperbranched polyesters, hyperbranched polyurethanes, hyperbranched polyureapolyurethanes, hyperbranched polyureas, hyperbranched polyethers and hyperbranched polyesteramides.

Hyperbranched polymers can, for example, be prepared as follows:
hyperbranched polycarbonates according to the non-prior-published Patent Application DE 10342523.3
hyperbranched polyesters according to WO 01/46296, DE 101 63 163, DE 102 19 508 or DE 102 40 817
hyperbranched polyethers according to WO 03/062306, WO 00/56802, DE 102 11 664 or DE 199 47 631
hyperbranched polyurethanes according to WO 97/02304 or DE 199 04 444
hyperbranched polyureapolyurethanes according to WO 97/02304 or DE 199 04 444
hyperbranched polyureas according to WO 03/066702 or the non-prior-published Patent Applications DE 10351401.5 or DE 102004006304.4
hyperbranched polyetheramines according to the non-prior-published Patent Application DE 10331770.8
hyperbranched polyesteramides according to WO 99/16810 or EP 1 036 106
hyperbranched polyamides according to the non-prior-published Patent Application DE 102004039101.7

The originally present functional groups (A or B groups) can be transfunctionalized by polymer-analogous reaction with suitable compounds. In this way, particularly well-adapted hyperbranched polymers are obtainable for use as demulsifiers.

The transfunctionalization of the hyperbranched polymers can be effected during the preparation of the polymers, immediately after the polymerization reaction or in a separate reaction.

If components which have further functional groups in addition to A and B groups are added before or during the polymer synthesis, a hyperbranched polymer having randomly distributed further functional groups, i.e. functional groups differing from A or B groups, is obtained.

Compounds used for the transfunctionalization may firstly comprise the desired functional group newly to be introduced and a second group which is capable of reacting with the B groups of the hyperbranched polymer used as starting material, with formation of a bond. An example of this is the reaction of an isocyanate group with a hydroxycarboxylic acid or an aminocarboxylic acid with formation of an acid functionality or the reaction of an OH group with acrylic anhydride with formation of a reactive acrylic double bond.

Examples of suitable functional groups which can be introduced by means of suitable reactants comprise in particular acidic or basic groups having H atoms and derivatives thereof, such as —OC(O)OR, —COOH, —COOR, —CONHR, —CONH₂, —OH, —SH, —NH₂, —NHR, —NR₂, —SO₃H, —SO₃R, —NHCOOR, —NHCONH₂, —NHCONHR, without there being any intention to limit the list thereto. If appropriate, the functional groups can also be converted into the corresponding salts with the aid of suitable acids or bases. Furthermore, for example, alkyl halides can also be used for quaternizing existing primary, secondary or tertiary amino groups. In this way, for example, water-soluble or water-dispersible hyperbranched polymers can be obtained.

The radicals R of said groups are as a rule straight-chain or branched alkyl radicals or are aryl radicals which may also furthermore be substituted. For example, they are C₁-C₃₀-alkyl radicals or are C₅-C₁₂-aryl radicals. It is also possible to use other functional groups, such as, for example, —CN or —OR.

For using the hyperbranched polymers as demulsifiers, it may be advantageous if hydrophilic and hydrophobic molecule moieties have a certain ratio to one another. A hyperbranched polymer can be rendered hydrophobic, for example, by using monofunctional hydrophobic compounds with which existing reactive groups are modified before, during or after the polymerization. Thus, the polymers according to the invention can be rendered hydrophobic, for example, by reaction with monofunctional, saturated or unsaturated aliphatic or aromatic amines, alcohols, carboxylic acids, epoxides or isocyanates.

Furthermore, for example, difunctional or higher-functional monomers having hydrophobic groups can also be incorporated in the form of polymerized units while increasing the molecular weight. For this purpose, for example, difunctional or higher-functional alcohols, difunctional or higher-functional amines, difunctional or higher-functional isocyanates, difunctional or higher-functional carboxylic acids, difunctional or higher-functional epoxides, which carry aromatic radicals or long-chain alkane, alkene or alkyne radicals in addition to the reactive groups, can be used.

Examples of such monomers are alcohols, such as glyceryl monostearate, glyceryl monooleate, hexanediol, octanediol, decanediol, dodecanediol, octadecanediol or dimeric fatty alcohols, amines, such as hexamethylenediamine, octanediamine or dodecanediamine, isocyanates, such as aromatic or aliphatic di- and polyisocyanates, for example diphenylmethane diisocyanate and the more highly oligomeric species thereof, tolylene diisocyanate, naphthylene diisocyanate, xylylene diisocyanate, hexamethylene diisocyanate, hexamethylene diisocyanate trimers, isophorone diisocyanate, bis(diisocyanatocyclohexyl)methane or bis(isocyanatomethyl)-cyclohexane, and acids, such as adipic acid, octanedioic acid, dodecanedioic acid, octadecanedioic acid and dimeric fatty acids.

Furthermore, the polymers according to the invention can be rendered hydrophilic by converting, for example, hyperbranched polymers comprising hydroxyl groups or amino groups into highly functional polymer polyols by reaction with alkylene oxides, for example ethylene oxide, propylene oxide or butylene oxide, ethylene oxide preferably being used. As a further option, however, difunctional or higher-functional alkylene oxide-alcohols or alkylene oxide-amines can also be used as synthesis components for the polymer.

It is also possible to produce hyperbranched polymers which have different types of functionalities. This can be effected, for example, by reaction with a mixture of different compounds for transfunctionalization, or by reacting only some of the originally present functional groups.

Furthermore, compounds having mixed functionality can be produced by using monomers of the type ABC or AB₂C for the polymerization, where C is a functional group which is not reactive with A or B under the chosen reaction conditions.

The demulsifiers used according to the invention are hyperbranched polymers having functional groups. It is also possible to use a plurality of different hyperbranched polymers as a mixture.

Hyperbranched polymers preferred as demulsifiers have —OC(O)OR, —COOH, —COOR, —CONH₂, —CONHR, —OH, —NH₂, —NHR or —SO₃H groups as terminal functional groups. OH—, COOH— and/or —OC(O)OR-terminated hyperbranched polymers have proven to be particularly advantageous for use as demulsifiers. The use of hyperbranched polymers which have OH and COOH groups or OH and —OC(O)OR groups or OH, COOH and —OC(O)OR groups is very particularly advantageous.

The hyperbranched polymers used according to the invention have, as a rule, at least 4 functional groups. In principle, there is no upper limit to the number of functional groups. However, products having too large a number of functional groups frequently have undesired properties, such as, for example, poor solubility or a very high viscosity. As a rule, the hyperbranched polymers used according to the invention therefore have not more than 100 functional groups. The hyperbranched polymers preferably have from 8 to 30 and particularly preferably from 8 to 20 functional groups.

Hyperbranched polymers having a weight average molecular weight M_{w} of from 1000 to 500 000 g/mol, preferably from 5000 to 200 000 g/mol, particularly preferably from 10 000 to 100 000 g/mol, measured by gel permeation chromatography using a polymethyl methacrylate standard, have proven useful as demulsifiers.

For use of the hyperbranched polymers as demulsifiers for breaking oil-in-water or water-in-oil emulsions, it may be advantageous if the polymers have no toxicity or only low toxicity for organisms living in water.

Furthermore, it may be advantageous if the hyperbranched polymers are biodegradable. Biodegradability of the hyperbranched polymers can in general be achieved by employing, in the case of the monomer building blocks used as starting materials, those monomers which are known to be biodegradable or can be assumed to be biodegradable. If, for example, it is desired to use a biodegradable hyperbranched polycarbonate or a biodegradable hyperbranched polyester as a demulsifier, such a product can be prepared, for example, using glycerol, glyceryl alkoxylates, ethylene glycol, stearyl alcohol, oleyl alcohol, oxalic acid, malonic acid, succinic acid, lactic acid, tartaric acid, adipic acid, stearic acid, oleic acid, linoleic acid or linolenic acid, without there being any intention to limit the list to these products.

A biodegradable hyperbranched polyamide or a biodegradable hyperbranched polyurea can be prepared, for example, on the basis of natural amino acids or biodegradable amines, biodegradable di- or tricarboxylic acids or urea.

### Hyperbranched Polycarbonates

Hyperbranched polycarbonates suitable as demulsifiers can be prepared by

a) reaction of at least one organic carbonate (A) of the general formula RO(CO)OR with at least one aliphatic alcohol (B) which has at least 30H groups, with elimination of alcohols ROH to give one or more condensates (K), R, in each case independently of one another, being a straight-chain or branched aliphatic, araliphatic or aromatic hydrocarbon radical having 1 to 20 carbon atoms, and
b) intermolecular reaction of the condensates (K) to give a highly functional, hyperbranched polycarbonate,
the ratio of the OH groups to the carbonates in the reaction mixture being chosen so that the condensates (K) have on average either one carbonate group and more than one OH group or one OH group and more than one carbonate group.

The radicals R of the organic carbonates (A) of the general formula RO(CO)OR which are used as a starting material are, in each case independently of one another, a straight-chain or branched aliphatic, araliphatic or aromatic hydrocarbon radical having 1 to 20 carbon atoms. The two radicals R may also be linked to one another with formation of a ring. It is preferably an aliphatic hydrocarbon radical and particularly preferably a straight-chain or branched alkyl radical having 1 to 5 carbon atoms.

Dialkyl or diaryl carbonates can be prepared, for example, from the reaction of aliphatic, araliphatic or aromatic alcohols, preferably monoalcohols, with phosgene. Furthermore, they can also be prepared by oxidative carbonylation of the alcohols or phenols by means of CO in the presence of noble metals, oxygen or NOₓ. Regarding methods of preparation of diaryl or dialkyl carbonates, also see “Ullmann's Encyclopedia of Industrial Chemistry”, 6th Edition, 2000 Electronic Release, Verlag Wiley-VCH.

Examples of suitable carbonates comprise aliphatic or aromatic carbonates, such as ethylene carbonate, 1,2- or 1,3-propylene carbonate, diphenyl carbonate, ditolyl carbonate, dixylyl carbonate, dinaphthyl carbonate, ethyl phenyl carbonate, dibenzyl carbonate, dimethyl carbonate, diethyl carbonate, dipropyl carbonate, dibutyl carbonate, diisobutyl carbonate, dipentyl carbonate, dihexyl carbonate, dicyclohexyl carbonate, diheptyl carbonate, dioctyl carbonate, didecyl carbonate and didodecyl carbonate.

Aliphatic carbonates are preferably used, in particular those in which the radicals comprise 1 to 5 carbon atoms, such as, for example, dimethyl carbonate, diethyl carbonate, dipropyl carbonate, dibutyl carbonate or diisobutyl carbonate.

The organic carbonates are reacted with at least one aliphatic alcohol (B) which has at least 3 OH groups, or mixtures of two or more different alcohols.

Examples of compounds having at least three OH groups are glycerol, trimethylolmethane, trimethylolethane, trimethylolpropane, 1,2,4-butanetriol, tris(hydroxymethyl)amine, tris(hydroxyethyl)amine, tris(hydroxypropyl)amine, pentaerythritol, bis(trimethylolpropane) or sugars, such as, for example, glucose, trifunctional or higher-functional polyetherols based on trifunctional or higher-functional alcohols and ethylene oxide, propylene oxide or butylene oxide, or polyesterols. Glycerol, trimethylolethane, trimethylolpropane, 1,2,4-butanetriol, pentaerythritol and polyetherols thereof based on ethylene oxide or propylene oxide are particularly preferred.

These polyfunctional alcohols can also be used as a mixture with difunctional alcohols (B′), with the proviso that the average OH functionality of all alcohols used is altogether greater than 2. Examples of suitable compounds having two OH groups comprise ethylene glycol, diethylene glycol, triethylene glycol, 1,2- and 1,3-propanediol, dipropylene glycol, tripropylene glycol, neopentylglycol, 1,2-, 1,3- and 1,4-butanediol, 1,2-, 1,3- and 1,5-pentanediol, hexanediol, cyclopentanediol, cyclohexanediol, cyclohexanedimethanol and difunctional polyetherols or polyesterols.

The reaction of the carbonate with the alcohol or alcohol mixture to give the highly functional hyperbranched polycarbonate according to the invention which is used is effected with elimination of the monofunctional alcohol or phenol from the carbonate molecule.

The highly functional hyperbranched polycarbonates formed by the process described are terminated with hydroxyl groups and/or with carbonate groups after the reaction, i.e. without further modification. They are readily soluble in various solvents, for example in water, alcohols, such as methanol, ethanol or butanol, alcohol/water mixtures, acetone, 2-butanone, ethyl acetate, butyl acetate, methoxypropyl acetate, methoxyethyl acetate, tetrahydrofuran, dimethylformamide, dimethylacetamide, N-methylpyrrolidone, ethylene carbonate or propylene carbonate.

In the context of this invention, the highly functional polycarbonate is to be understood as meaning a product which, in addition to the carbonate groups which form the polymer skeleton, furthermore have at least four, preferably at least eight, functional terminal or side groups. The functional groups are carbonate groups and/or OH groups. In principle, there is no upper limit to the number of functional terminal or side groups, but products having a very large number of functional groups may have undesired properties, such as, for example, high viscosity or poor solubility. The highly functional polycarbonates of the present invention generally have not more than 500 functional terminal or side groups, preferably not more than 100, in particular not more than 30, functional terminal or side groups.

In the preparation of the highly functional polycarbonates, it is necessary to adjust the ratio of the compounds comprising OH groups to the carbonate so that the resulting simplest condensate (referred to below as condensate (K)) comprises on average either one carbonate group and more than one OH group or one OH group and more than one carbonate group. The simplest structure of the condensate (K) from a carbonate (A) and a di- or polyalcohol (B) gives the arrangement XYₙ or YₙX, where X is a carbonate group, Y is a hydroxyl group and n is as a rule a number from 1 to 6, preferably from 1 to 4, particularly preferably from 1 to 3. The reactive group which results as an individual group is referred to below generally as “focal group”.

If, for example, the reaction ratio is 1:1 in the preparation of the simplest condensate (K) from a carbonate and a dihydric alcohol, a molecule of the type XY results on average, illustrated by the general formula 1.

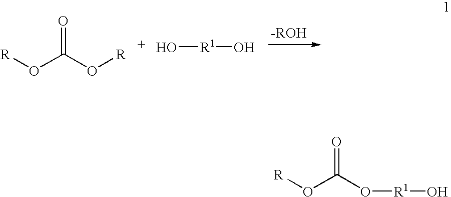

In the preparation of the condensate (K) from a carbonate and a trihydric alcohol with a reaction ratio of 1:1, a molecule of the type XY₂ results on average, illustrated by the general formula 2. The focal group here is a carbonate group.

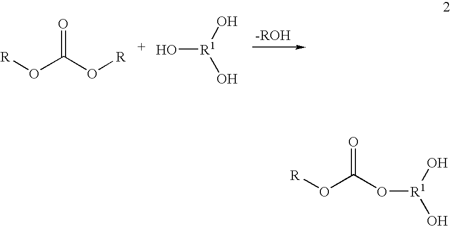

In the preparation of the condensate (K) from a carbonate and a tetrahydric alcohol, likewise with the reaction ratio of 1:1, a molecule of the type XY₃ results on average, illustrated by the general formula 3. The focal group here is a carbonate group.

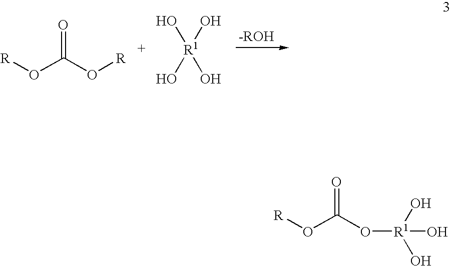

In the formulae 1 to 3, R has the meaning defined at the outset and R¹ is an aliphatic radical.

Furthermore, the preparation of the condensate (K) can also be effected, for example, from a carbonate and a trihydric alcohol, illustrated by the general formula 4, the molar reaction ratio being 2:1. Here, a molecule of the type X₂Y results on average, and the focal group here is an OH group. In the formula 4, R and R¹ have the same meaning as in the formulae 1 to 3.

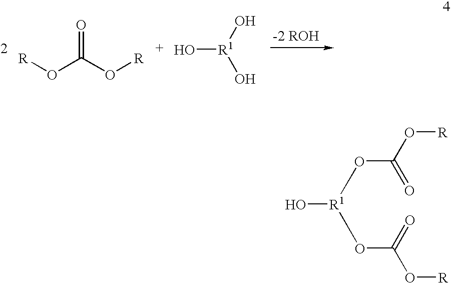

If difunctional compounds, for example a dicarbonate or a diol, are added in addition to the components, this results in a lengthening of the chains, as illustrated, for example, in the general formula 5. Once again, a molecule of the type XY₂ results on average, and the focal group is a carbonate group.

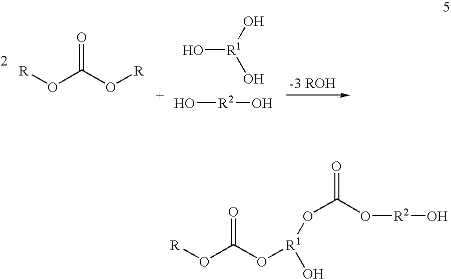

In formula 5, R² is an organic, preferably aliphatic, radical, and R and R¹ are defined as described above.

The simple condensates (K) described by way of example in the formulae 1-5 preferably undergo, according to the invention, an intermolecular reaction with formation of highly functional polycondensates, referred to below as polycondensates (P). The reaction to give the condensate (K) and to give the polycondensate (P) is usually effected at a temperature of from 0 to 250° C., preferably at from 60 to 160° C., in the absence of a solvent or in solution. In general, it is possible to use all solvents which are inert to the respective starting materials. Organic solvents, such as, for example, decane, dodecane, benzene, toluene, chlorobenzene, xylene, dimethylformamide, dimethylacetamide or solvent naphtha, are preferably used.

In a preferred embodiment, the condensation reaction is carried out in the absence of a solvent. The monofunctional alcohol ROH liberated in the reaction or the phenol can be removed from the reaction equilibrium by distillation, if appropriate under reduced pressure, in order to accelerate the reaction.

If it is intended to distill off, it is usually advisable to use such carbonates which liberate, during the reaction, alcohols ROH having a boiling point of less than 140° C.

In order to accelerate the reaction, catalysts or catalyst mixtures may also be added. Suitable catalysts are compounds which catalyze for esterification or transesterification reactions, for example alkali metal hydroxides, alkali metal carbonates, alkali metal bicarbonates, preferably of sodium, of potassium or of cesium, tertiary amines, guanidines, ammonium compounds, phosphonium compounds, organic aluminum, tin, zinc, titanium, zirconium or bismuth compounds, and furthermore so-called double-metal cyanide (DMC) catalysts, as described, for example, in DE 10138216 or in DE 10147712.

Potassium hydroxide, potassium carbonate, potassium bicarbonate, diazabicyclooctane (DABCO), diazabicyclononene (DBN), diazabicycloundecene (DBU), imidazoles, such as imidazole, 1-methylimidazole or 1,2-dimethylimidazole, titanium tetrabutylate, titanium tetraisopropylate, dibutyltin oxide, dibutyltin dilaurate, tin dioctoate, zirconium acetylacetonate or mixtures thereof are preferably used.

The addition of the catalyst is generally effected in an amount of from 50 to 10 000, preferably from 100 to 5000, ppm by weight, based on the amount of the alcohol or alcohol mixture used.

Furthermore, it is also possible to control the intermolecular polycondensation reaction by addition of a suitable catalyst, as well as by the choice of a suitable temperature. Furthermore, the average molecular weight of the polymer (P) can be established by the composition of the starting components and via the residence time.

The condensates (K) or the polycondensates (P) which were prepared at elevated temperature are usually stable over a relatively long period at room temperature.

Owing to the characteristics of the condensates (K), it is possible that polycondensates (P) having different structures, which have branches but no crosslinks, can result from the condensation reaction. Furthermore, the polycondensates (P) ideally have either a carbonate group as the focal group and more than two OH groups or an OH group as the focal group and more than two carbonate groups. The number of reactive groups arises from the characteristics of the condensates (K) used and the degree of polycondensation.

For example, a condensate (K) according to the general formula 2 can react by intermolecular tricondensation to give two different polycondensates (P) which are reproduced in the general formulae 6 and 7.

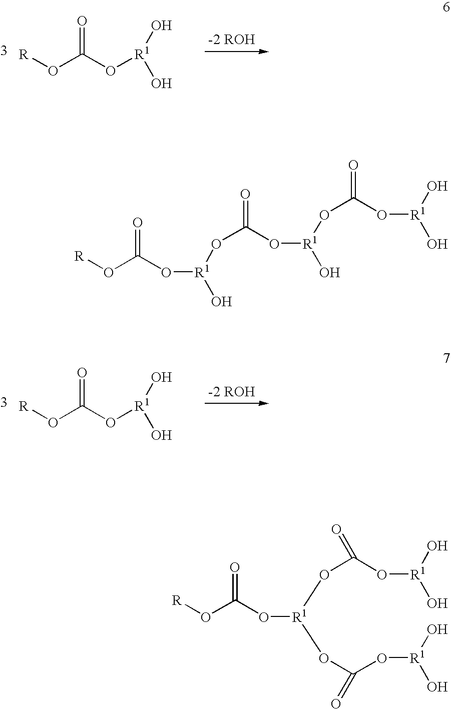

In formulae 6 and 7, R and R¹ are as defined above.

There are various possibilities for terminating the intermolecular polycondensation reaction. For example, the temperature can be reduced to a range in which the reaction stops and the product (K) or the polycondensate (P) is storage-stable.

In a further embodiment, a product having groups reactive toward the focal group of (P) can be added to the product (P) for terminating the reaction as soon as a polycondensate (P) having the desired degree of polycondensation is present as a result of the intermolecular reaction of the condensate (K). Thus, in the case of a carbonate group as the focal group, for example, a mono-, di- or polyamine can be added. In the case of a hydroxyl group as the focal group, for example, a mono-, di- or polyisocyanate, a compound comprising epoxide groups or an acid derivative reactive with OH groups can be added to the product (P).

The preparation of the highly functional polycarbonates according to the invention is generally effected in a pressure range of from 0.1 mbar to 20 bar, preferably at from 1 mbar to 5 bar, in reactors or reactor cascades which are operated in the batch mode, semicontinuously or continuously.

By the abovementioned adjustment of the reaction conditions and, if appropriate, by the choice of the suitable solvent, the products can be further processed after the preparation without further purification.

In a further preferred embodiment, the polycarbonates may comprise further functional groups in addition to the functional groups already obtained by the reaction. The functionalization can be effected during the increase in molecular weight or subsequently, i.e. after the end of the actual polycondensation.

If components which have further functional groups or functional elements in addition to hydroxyl or carbonate groups are added before or during the increase in molecular weight, a polycarbonate polymer having randomly distributed functionalities differing from the carbonate or hydroxyl groups is obtained.

Such effects can be achieved, for example, by adding, during the polycondensation, compounds which carry further functional groups or functional elements, such as mercapto groups, primary, secondary or tertiary amino groups, ether groups, derivatives of carboxylic acids, derivatives of sulfonic acids, derivatives of phosphonic acids, aryl radicals or long-chain alkyl radicals in addition to hydroxyl groups or carbonate groups. For modification by means of carbamate groups, for example ethanolamine, propanolamine, isopropanolamine, 2-(butylamino)ethanol, 2-cyclohexylamino)ethanol, 2-amino-1-butanol, 2-(2′-aminoethoxy)ethanol and higher alkoxylation products of ammonia, 4-hydroxypiperidine, 1-hydroxyethylpiperazine, diethanolamine, dipropanolamine, diisopropanolamine, tris(hydroxymethyl)-aminomethane, tris(hydroxyethyl)aminomethane, ethylenediamine, propylenediamine, hexamethylenediamine or isophoronediamine can be used.

For the modification with mercapto groups, for example, mercaptoethanol can be used. Tertiary amino groups can be produced, for example, by incorporation of N-methyldiethanolamine, N-methyldipropanolamine or N,N-dimethylethanolamine. Ether groups can be generated, for example, by incorporating difunctional or higher-functional polyetherols by condensation. By reaction with long-chain alkanediols, it is possible to introduce long-chain alkyl radicals, and the reaction with alkyl or aryl diisocyanates generates polycarbonates having alkyl, aryl and urethane groups.

Subsequent functionalization can be obtained by reacting the resulting highly functional, hyperbranched polycarbonate with a suitable functionalizing reagent which can react with OH and/or carbonate groups of the polycarbonate.

Highly functional, hyperbranched polycarbonates comprising hydroxyl groups can be modified, for example, by adding molecules comprising acid groups or isocyanate groups. For example, polycarbonates comprising acid groups can be obtained by reaction with compounds comprising anhydride groups.

Furthermore, highly functional polycarbonates comprising hydroxyl groups can also be converted into highly functional polycarbonate-polyetherpolyols by reaction with alkylene oxides, for example ethylene oxide, propylene oxide or butylene oxide.

A major advantage of the process according to the invention is its cost-efficiency. Both the reaction to give a condensate (K) or polycondensate (P) and the reaction of (K) or (P) to give polycarbonates having different functional groups or elements can be effected with one reaction apparatus, which is technically and economically advantageous

### Hyperbranched Polyesters

Hyperbranched polyesters preferred for use as demulsifiers are obtainable by reacting at least one aliphatic, cycloaliphatic, araliphatic or aromatic dicarboxylic acid (A₂) or derivatives thereof with

a) at least one at least trifunctional aliphatic, cycloaliphatic, araliphatic or aromatic alcohol (B₃), or
b) with at least one dihydric aliphatic, cycloaliphatic, araliphatic or aromatic alcohol (B₂) and at least one x-functional aliphatic, cycloaliphatic, araliphatic or aromatic alcohol (Cₓ) which has more than two OH groups, where x is a number greater than 2, preferably from 3 to 8, particularly preferably from 3 to 6, very particularly preferably 3 or 4 and in particular 3,
or by reacting at least one aliphatic, cycloaliphatic, araliphatic or aromatic carboxylic acid (D_{y}) or derivatives thereof which have more than two acid groups, where y is a number greater than 2, preferably from 3 to 8, particularly preferably from 3 to 6, very particularly preferably 3 or 4 and in particular 3, with
c) at least one at least difunctional aliphatic, cycloaliphatic, araliphatic or aromatic alcohol (B₂), or
d) with at least one dihydric aliphatic, cycloaliphatic, araliphatic or aromatic alcohol (B₂) and at least one x-functional aliphatic, cycloaliphatic, araliphatic or aromatic alcohol (Cₓ) which has more than two OH groups, where x is a number greater than 2, preferably from 3 to 8, particularly preferably from 3 to 6, very particularly preferably 3 or 4 and in particular 3,
e) if appropriate in the presence of further functionalized building blocks E and
f) optionally subsequent reaction with a monocarboxylic acid or a monocarboxylic acid derivative F,
the ratio of the reactive groups in the reaction mixture being chosen so that a molar ratio of OH groups to carboxyl groups or derivatives thereof of from 5:1 to 1:5, preferably from 4:1 to 1:4, particularly preferably from 3:1 to 1:3 and very particularly preferably from 2:1 to 1:2 results.

In the context of the present invention, hyperbranched polyesters are understood as meaning uncrosslinked polyesters having hydroxyl and carboxyl groups, which are both structurally and molecularly nonuniform. In the context of this document, uncrosslinked means that a degree of crosslinking of less than 15% by weight, preferably of less than 10% by weight, determined by the insoluble fraction of the polymer, is present. The insoluble fraction of the polymer was determined by extraction for four hours with the same solvent as used for the gel permeation chromatography, i.e. tetrahydrofuran or hexafluoroisopropanol, depending on the solvent in which the polymer has better solubility, in a Soxhlet apparatus and, after drying of the residue to constant weight, weighing of the remaining residue.

The dicarboxylic acids (A₂) include, for example, aliphatic dicarboxylic acids, such as oxalic acid, malonic acid, succinic acid, glutaric acid, adipic acid, pimelic acid, suberic acid, azelaic acid, sebacic acid, undecane-α,ω-dicarboxylic acid, dodecane-α,ω-dicarboxylic acid, cis- and trans-cyclohexane-1,2-dicarboxylic acid, cis- and trans-cyclohexane-1,3-dicarboxylic acid, cis- and trans-cyclohexane-1,4-dicarboxylic acid, cis- and trans-cyclopentane-1,2-dicarboxylic acid, cis- and trans-cyclopentane-1,3-dicarboxylic acid. Furthermore, aromatic dicarboxylic acids, such as, for example, phthalic acid, isophthalic acid or terephthalic acid, can also be used. Unsaturated dicarboxylic acids, such as maleic acid or fumaric acid, can also be used.

Said dicarboxylic acids may also be substituted by one or more radicals selected from C₁-C₁₀-alkyl groups, C₃-C₁₂-cycloalkyl groups, alkylene groups, such as methylene or ethylidene, or C₆-C₁₄-aryl groups. The following may be mentioned as typical examples of substituted dicarboxylic acids: 2-methylmalonic acid, 2-ethylmalonic acid, 2-phenylmalonic acid, 2-methylsuccinic acid, 2-ethylsuccinic acid, 2-phenylsuccinic acid, itaconic acid and 3,3-dimethylglutaric acid.

Furthermore, mixtures of two or more of the abovementioned dicarboxylic acids can be used.

The dicarboxylic acids can be used either as such or in the form of their derivatives.

C₁-C₄-Alkyl is specifically methyl, ethyl, isopropyl, n-propyl, n-butyl, isobutyl, sec-butyl and tert-butyl, preferably methyl, ethyl and n-butyl, particularly preferably methyl and ethyl and very particularly preferably methyl.

It is also possible to use a mixture of a dicarboxylic acid and one or more of its derivatives. It is equally possible to use a mixture of a plurality of different derivatives of one or more dicarboxylic acids.

Particularly preferably, malonic acid, succinic acid, glutaric acid, adipic acid, 1,2-, 1,3- or 1,4-cyclohexanedicarboxylic acid (hexahydrophthalic acids), phthalic acid, isophthalic acid, terephthalic acid or mono- or dialkyl esters thereof are used.

Tricarboxylic acids or polycarboxylic acids (D_{y}) which can be reacted are, for example, aconitic acid, 1,3,5-cyclohexanetricarboxylic acid, 1,2,4-benzenetricarboxylic acid, 1,3,5-benzenetricarboxylic acid, 1,2,4,5-benzenetetracarboxylic acid (pyromellitic acid) and mellitic acid and low molecular weight polyacrylic acids

Tricarboxylic acids or polycarboxylic acids (D_{y}) can be used either as such or in the form of derivatives.

Derivatives are the relevant anhydrides in monomeric or polymeric form, mono- or dialkyl esters, preferably mono- or di-C₁-C₄-alkyl esters, particularly preferably mono- or dimethyl esters and the corresponding mono- or diethyl esters, and furthermore mono- and divinyl esters and mixed esters, preferably mixed esters having different C₁-C₄-alkyl components, particularly preferably mixed methyl ethyl esters.

It is also possible to use a mixture of a tri- or polycarboxylic acid and one or more of its derivatives, for example a mixture of pyromellitic acid and pyromellitic anhydride. It is also possible to use a mixture of a plurality of different derivatives of one or more tri- or polycarboxylic acids, for example a mixture of 1,3,5-cyclohexanetricarboxylic acid and pyromellitic dianhydride.

Examples of diols (B₂) used are ethylene glycol, propane-1,2-diol, propane-1,3-diol, butane-1,2-diol, butane-1,3-diol, butane-1,4-diol, butane-2,3-diol, pentane-1,2-diol, pentane-1,3-diol, pentane-1,4-diol, pentane-1,5-diol, pentane-2,3-diol, pentane-2,4-diol, hexane-1,2-diol, hexane-1,3-diol, hexane-1,4-diol, hexane-1,5-diol, hexane-1,6-diol, hexane-2,5-diol, heptane-1,2-diol, 1,7-heptanediol, 1,8-octanediol, 1,2-octanediol, 1,9-nonanediol, 1,2-decanediol, 1,10-decanediol, 1,2-dodecanediol, 1,12-dodecanediol, 1,5-hexadiene-3,4-diol, 1,2- and 1,3-cyclopentanediols, 1,2-, 1,3- and 1,4-cyclohexanediols, 1,1-, 1,2-, 1,3- and 1,4-bis(hydroxymethyl)cyclohexanes, 1,1-, 1,2-, 1,3- and 1,4-bis(hydroxyethyl)cyclohexanes, neopentylglycol, (2)-methyl-2,4-pentanediol, 2,4-dimethyl-2,4-pentanediol, 2-ethyl-1,3-hexanediol, 2,5-dimethyl-2,5-hexanediol, 2,2,4-trimethyl-1,3-pentanediol, pinacol, diethylene glycol, triethylene glycol, dipropylene glycol, tripropylene glycol, polyethylene glycols HO(CH₂CH₂O)ₙ—H or polypropylene glycols HO(CH[CH₃]CH₂O)ₙ—H, where n is an integer and n is ≧4, polyethylenepolypropylene glycols, it being possible for the sequence of the ethylene oxide of the propylene oxide units to be block-by-block or random, polytetramethylene glycols, preferably up to a molecular weight up to 5000 g/mol, poly-1,3-propanediols, preferably having a molecular weight up to 5000 g/mol, polycaprolactones or mixtures of two or more members of the above compounds. One or both hydroxyl groups in the abovementioned diols can be substituted by SH groups. Preferably used diols are ethylene glycol, 1,2-propanediol, 1,3-propanediol, 1,4-butanediol, 1,5-pentanediol, 1,6-hexanediol, 1,8-octanediol, 1,2-, 1,3- and 1,4-cyclohexanediol, 1,3- and 1,4-bis(hydroxymethyl)cyclohexane and diethylene glycol, triethylene glycol, dipropylene glycol, tripropylene glycol, polyethylene glycols HO(CH₂CH₂O)ₙ—H or polypropylene glycols HO(CH[CH₃]CH₂O)ₙ—H, where n is an integer and n is ≧4, polyethylenepolypropylene glycols, it being possible for the sequence of the ethylene oxide of the propylene oxide units to be block-by-block or random, or polytetramethylene glycols, preferably up to a molecular weight up to 5000 g/mol.

The dihydric alcohols B₂ can optionally also comprise further functionalities, such as, for example, carbonyl, carboxyl, alkoxycarbonyl or sulfonyl functions, such as, for example, dimethylolpropionic acid or dimethylolbutyric acid, and C₁-C₄-alkyl esters thereof, glyceryl monostearate or glyceryl monooleate.

At least trifunctional alcohols (Cₓ) comprise glycerol, trimethylolmethane, trimethylolethane, trimethylolpropane, 1,2,4-butanetriol, tris(hydroxymethyl)amine, tris(hydroxyethyl)amine, tris(hydroxypropyl)amine, pentaerythritol, diglycerol, triglycerol or higher condensates of glycerol, di(trimethylolpropane), di(pentaerythritol), trishydroxymethyl isocyanurate, tris(hydroxyethyl) isocyanurate (THEIC), tris(hydroxypropyl) isocyanurate, inositols or sugars, such as, for example, glucose, fructose or sucrose, sugar alcohols, such as, for example, sorbitol, mannitol, threitol, erythritol, adonitol (ribitol), arabitol (lyxitol), xylitol, dulcitol (galactitol), maltitol, isomalt, trifunctional or higher-functional polyetherols based on trifunctional or higher-functional alcohols and ethylene oxide, propylene oxide and/or butylene oxide.

Glycerol, diglycerol, triglycerol, trimethylolethane, trimethylolpropane, 1,2,4-butanetriol, pentaerythritol, tris(hydroxyethyl) isocyanurate and polyetherols thereof based on ethylene oxide and/or propylene oxide are particularly preferred.

The reaction can be carried out in the presence or absence of a solvent. Suitable solvents are, for example, hydrocarbons, such as paraffins, aromatics, ethers and ketones. The reaction is preferably carried out in the absence of solvents. The reaction can be effected in the presence of a dehydrating agent as an additive, which is added at the beginning of the reaction. For example, molecular sieves, in particular molecular sieve 4 Å, MgSO₄ and Na₂SO₄ are suitable. Water or alcohol formed during the reaction can also be distilled off and it is possible to use, for example, a water separator in which the water is removed with the aid of an entraining agent.

The reaction can be carried out in the absence of a catalyst. Preferably, however, the procedure is effected in the presence of at least one catalyst. Acidic inorganic, organometallic or organic catalysts or mixtures of a plurality of acidic inorganic, organometallic or organic catalysts are preferred.

For example, sulfuric acid, sulfates and hydrogen sulfates, such as sodium hydrogen sulfate, phosphoric acid, phosphonic acid, hypophosphorous acid, aluminum sulfate hydrate, alum, acidic silica gel (pH≦6, in particular ≦5) and acidic alumina may be mentioned as acidic inorganic catalysts in the context of the present invention. Furthermore, for example, aluminum compounds of the general formula Al(OR¹)₃ and titanates are preferred. Preferred acidic organometallic catalysts are furthermore, for example, dialkyltin oxides or dialkyltin esters. Preferred acidic organic catalysts are acidic organic compounds having, for example, phosphate groups, sulfo groups, sulfate groups or phosphonic acid groups. It is also possible to use acidic ion exchangers as acidic organic catalysts.

The reaction is carried out at temperatures of from 60 to 250° C.

The hyperbranched polyesters used according to the invention have a molecular weight M_{w} of at least 500, preferably at least 600 and particularly preferably 1000 g/mol. The upper limit of the molecular weight M_{w} is preferably 500 000 g/mol, particularly preferably not more than 200 000 and very particularly preferably not more than 100 000 g/mol.

The data on the polydispersity and on the number average and weight average molecular weight Mₙ and M_{w} relate here to gel permeation chromatography measurements, polymethyl methacrylate having been used as a standard and tetrahydrofuran, dimethylformamide, dimethylacetamide or hexafluoroisopropanol as an eluent. The method is described in Analytiker Taschenbuch Vol. 4, pages 433 to 442, Berlin 1984.

The polydispersity of the polyesters used according to the invention is in general from 1.2 to 50, preferably from 1.4 to 40, particularly preferably from 1.5 to 30 and very particularly preferably from 2 to 30.

### Hyperbranched Polyurethanes

The term “polyurethanes” in the context of this invention comprises, over and above the usual understanding, polymers which can be obtained by reacting di- or polyisocyanates with compounds having active hydrogen, and which may be linked by urethane structures but also, for example, by urea, allophanate, biuret, carbodiimide, amide, uretonimine, uretdione, isocyanurate or oxazolidone structures.

For the synthesis of the hyperbranched polyurethanes used according to the invention, ABₓ monomers which have both isocyanate groups and groups which can react with isocyanate groups with formation of a link are preferably used. x is a natural number of from 2 to 8, preferably 2 or 3. A is either an isocyanate group and B is groups reactive with this, or the converse is true.

The groups reactive with the isocyanate groups are preferably OH, NH₂, NHR or SH groups.

The ABₓ monomers can be prepared in a known manner. ABₓ monomers can be synthesized, for example, by the method described in WO 97/02304 using protective group techniques. This technique is explained by way of example for the preparation of an AB₂ monomer from toluene 2,4-diisocyanate (TDI) and trimethylolpropane. First, one of the isocyanate groups of the TDI is capped in a known manner, for example by reaction with an oxime. The remaining free NCO group is reacted with trimethylolpropane, only one of the three OH groups reacting with the isocyanate group, while two OH groups are blocked by acetylation. After elimination of the protective group, a molecule having an isocyanate group and 2 OH groups is obtained.

The ABₓ molecule can be particularly advantageously synthesized by the method described in DE-A 199 04 444, in which no protective groups are required. In this method, di- or polyisocyanates are used and are reacted with compounds which have at least two groups reactive with isocyanate groups. At least one of the reactants has groups having reactivity differing from the other reactant. Preferably, both reactants have groups having reactivity differing from the other reactant. The reaction conditions are chosen so that only certain reactive groups can react with one another.

Suitable di- and polyisocyanates are the aliphatic, cycloaliphatic and aromatic isocyanates known from the prior art. Preferred di- or polyisocyanates are diphenylmethane 4,4′-diisocyanate, the mixtures of monomeric diphenylmethane diisocyanates and oligomeric diphenylmethane diisocyanates (polymer MDI), tetramethylene diisocyanate, hexamethylene diisocyanate, methylenebis(cyclohexyl) 4,4′-diisocyanate, xylylene diisocyanate, tetramethylxylylene diisocyanate, dodecyl diisocyanate, lysine alkyl ester diisocyanate, alkyl being C₁- to C₁₀-alkyl, 2,2,4- or 2,4,4-trimethylhexamethylene 1,6-diisocyanate, 1,4-diisocyanatocyclohexane or 4-isocyanatomethyloctamethylene 1,8-diisocyanate.

Di- or polyisocyanates having NCO groups of different reactivity, such as tolylene 2,4-diisocyanate (2,4-TDI), diphenylmethane 2,4′-diisocyanate (2,4′-MDI), triisocyanatotoluene, isophorone diisocyanate (IPDI), 2-butyl-2-ethylpentamethylene diisocyanate, 2-isocyanatopropylcyclohexyl isocyanate, 3(4)-isocyanatomethyl-1-methylcyclohexyl isocyanate, 1,4-diisocyanato-4-methylpentane, methylenebis(cyclohexyl) 2,4′-diisocyanate and 4-methylcyclohexane 1,3-diisocyanate (H-TDI), are particularly preferred. Furthermore, isocyanates (b) whose NCO groups initially have the same reactivity but in which a decrease in reactivity can be induced in the second NCO group by initial addition of an alcohol or amine at an NCO group are particularly preferred Examples of these are isocyanates whose NCO groups are coupled via a delocalized electronic system, e.g. phenylene 1,3- and 1,4-diisocyanate, naphthylene 1,5-diisocyanate, diphenyl diisocyanate, tolidine diisocyanate or tolylene 2,6-diisocyanate.

It is furthermore possible to use, for example, oligo- or polyisocyanates which can be prepared from said di- or polyisocyanates or mixtures thereof by linkage by means of urethane, allophanate, urea, biuret, uretdione, amide, isocyanurate, carbodiimide, uretonimine, oxadiazinetrione or iminoxadiazinedione structures.

Di-, tri- or tetrafunctional compounds whose functional groups have different reactivity with respect to NCO groups are preferably used as compounds having at least two groups reactive with isocyanates. Compounds having at least one primary and at least one secondary hydroxyl group, at least one hydroxyl group and at least one mercapto group, particularly preferably having at least one hydroxyl group and at least one amino group in the molecule, in particular aminoalcohols, aminodiols and aminotriols, are preferred, since the reactivity of the amino group with respect to the hydroxyl group in the reaction of isocyanate is substantially higher.

Examples of said compounds having at least two groups reactive with isocyanates are propylene glycol, glycerol, mercaptoethanol, ethanolamine, N-methylethanolamine, diethanolamine, ethanolpropanolamine, dipropanolamine, diisopropanolamine, 2-amino-1,3-propanediol, 2-amino-2-methyl-1,3-propanediol or tris(hydroxymethyl)-aminomethane. Furthermore, mixtures of said compounds can also be used.

The preparation of an AB₂ molecule may be explained by way of example for the case of a diisocyanate with an aminodiol. Here, one mole of a diisocyanate is first reacted with one mole of an aminodiol at low temperatures, preferably in the range from −10 to 30° C. In this temperature range, virtually complete suppression of the urethane formation reaction takes place and the more reactive NCO groups of the isocyanate react exclusively with the amino group of the aminodiol. The ABₓ molecule formed has one free NCO group and two free OH groups and can be used for the synthesis of a highly branched polyurethane.

By heating and/or catalyst addition, this AB₂ molecule can undergo an intermolecular reaction to give a highly branched polyurethane. The synthesis of the highly branched polyurethane can advantageously be effected without prior isolation of the ABₓ molecule in a further reaction step at elevated temperature, preferably in the range from 30 to 80° C. With the use of the described AB₂ molecule having two OH groups and one NCO group, a highly branched polymer which has one free NCO group per molecule and—depending on the degree of polymerization—a larger or smaller number of OH groups forms. The reaction can be carried out up to high conversions, with the result that very high molecular weight structures are obtained. It can, however, also be terminated, for example, by adding suitable monofunctional compounds or by adding one of the starting compounds for the preparation of the AB₂ molecule on reaching the desired molecular weight. Depending on the starting compound used for the termination, either completely NCO-terminated or completely OH-terminated molecules form.

Alternatively, for example, an AB₂ molecule can also be prepared from one mole of glycerol and 2 mol of 2,4-TDI. At low temperature, the primary alcohol groups and the isocyanate group in the 4-position react preferentially, and an adduct is formed which has one OH group and two isocyanate groups, which adduct, as described, can be reacted at relatively high temperatures to give a hyperbranched polyurethane. A hyperbranched polymer which has one free OH group and—depending on the degree of polymerization—a larger or smaller number of NCO groups first forms.

The preparation of the hyperbranched polyurethanes can be effected in principle without a solvent but is preferably effected in a solution. Solvents which are suitable in principle are all compounds which are liquid at the reaction temperature and inert to the monomers and polymers.

Other products are obtainable by further synthesis variants. AB₃ molecules can be obtained, for example, by reaction of diisocyanates with compounds having at least 4 groups reactive toward isocyanates. The reaction of tolylene 2,4-diisocyanate with tris(hydroxymethyl)aminomethane may be mentioned by way of example.

For terminating the polymerization, it is also possible to use polyfunctional compounds which can react with the respective A groups. In this way, a plurality of small hyperbranched molecules can be linked to give a large hyperbranched molecule. Hyperbranched polyurethanes having chain-extended branches can be obtained, for example, by additionally using a diisocyanate and a compound which has two groups reactive with isocyanate groups for the polymerization reaction, in addition to the ABₓ molecules, in a molar ratio of 1:1. These additional AA or BB compounds may also have further functional groups, which however are not permitted to be reactive toward the A or B groups under the chosen reaction conditions. In this way, further functionalities can be introduced into the hyperbranched polymer.

Further synthesis variants for hyperbranched polyurethanes are to be found in DE 100 13187 and DE 100 30 869.

The functional groups of the hyperbranched polyurethanes obtained by the synthesis reaction can, as described above, be rendered hydrophobic, rendered hydrophilic or be transfunctionalized. Owing to their reactivity, those hyperbranched polyurethanes which have isocyanate groups are very particularly suitable for the transfunctionalization. OH— or NH₂-terminated polyurethanes can also be transfunctionalized by means of suitable reactants.

Preferred groups which are introduced into the hyperbranched polyurethanes are —COOH, —CONH₂, —OH, —NH₂, —NHR, —NR₂, —NR₃⁺ and —SO₃H and salts thereof.

Groups which have sufficiently acidic H atoms can be converted into the corresponding salts by treatment with suitable bases. In an analogous manner, basic groups can be converted with suitable acids into the corresponding salts Water-soluble hyperbranched polyurethanes can thus be obtained.

By reacting NCO-terminated products with saturated or unsaturated aliphatic alcohols and amines, in particular with C₈-C₄₀-alkyl radicals, it is possible to obtain products which have been rendered hydrophobic.

Products which have been rendered hydrophilic but are nonionic can be obtained by reaction of NCO-terminated polymers with polyetheralcohols, such as, for example, di-, tri- or tetra- or polyethylene glycol.

Acid groups can be introduced, for example, by reaction with hydroxycarboxylic acids, hydroxysulfonic acids or amino acids. 2-Hydroxyacetic acid, 4-hydroxybenzoic acid, 12-hydroxydodecanoic acid, 2-hydroxyethanesulfonic acid, glycine or alanine may be mentioned as examples of suitable reactants.

It is also possible to produce hyperbranched polyurethanes which have different types of functionalities. This can be effected, for example, by reaction with a mixture of different compounds, or by reacting only some of the originally present functional groups, for example only some of the OH and/or NCO groups.

The transfunctionalization of the hyperbranched polyurethane can advantageously be effected directly after the polymerization reaction, without the NCO-terminated polyurethane being isolated beforehand. Functionalization can, however, also be effected in a separate reaction.

The hyperbranched polyurethanes used according to the invention have as a rule on average at least 4 and not more than 100 functional groups. Preferably, the hyperbranched polyurethanes have from 8 to 30 and particularly preferably from 8 to 20 functional groups. Preferably used hyperbranched polyurethanes have a weight average molecular weight M_{w} of from 1000 to 500 000 g/mol, preferably from 5000 to 200 000 g/mol, particularly preferably from 10 000 to 100 000 g/mol.

### Hyperbranched Polyureas

Highly functional hyperbranched polyureas which are used according to the invention as demulsifiers can be obtained, for example, by reacting one or more carbonates with one or more amines having at least two primary and/or secondary amino groups, at least one amine having at least three primary and/or secondary amino groups.

Suitable carbonates are aliphatic, aromatic or mixed aliphatic-aromatic carbonates; aliphatic carbonates, such as dialkyl carbonates having C₁-C₁₂-alkyl radicals, are preferred. Examples are ethylene carbonate, 1,2- or 1,3-propylene carbonate, diphenyl carbonate, ditolyl carbonate, dinaphthyl carbonate, ethyl phenyl carbonate, dibenzyl carbonate, dimethyl carbonate, diethyl carbonate, dipropyl carbonate, dibutyl carbonate, diisobutyl carbonate, dipentyl carbonate, dihexyl carbonate, diheptyl carbonate, dioctyl carbonate, didecyl carbonate or didodecyl carbonate. Particularly preferably used carbonates are dimethyl carbonate, diethyl carbonate, dibutyl carbonate and diisobutyl carbonate.

The carbonates are reacted with one or more amines having at least two primary and/or secondary amino groups, at least one amine having at least three primary and/or secondary amino groups. Amines having two primary and/or secondary amino groups result in chain extension within the polyureas, while amines having three or more primary or secondary amino groups cause the branching in the highly functional, hyperbranched polyureas obtained.

Suitable amines having two primary or secondary amino groups reactive toward a carbonate or carbamate group are, for example, ethylenediamine, N-alkylethylenediamine, propylenediamine, 2,2-dimethyl-1,3-propylenediamine, N-alkylpropylenediamine, butylenediamine, N-alkylbutylenediamine, pentanediamine, hexamethylenediamine, N-alkylhexamethylenediamine, heptanediamine, octanediamine, nonanediamine, decanediamine, dodecanediamine, hexadecanediamine, tolylenediamine, xylylenediamine, diaminodiphenylmethane, diaminodicyclohexylmethane, phenylenediamine, cyclohexylenediamine, bis(aminomethyl)cyclohexane, diaminodiphenyl sulfone, isophoronediamine, 2-butyl-2-ethyl-1,5-pentamethylenediamine, 2,2,4- or 2,4,4-trimethyl-1,6-hexamethylenediamine, 2-aminopropylcyclohexylamine, 3(4)-aminomethyl-1-methylcyclohexylamine, 1,4-diamino-4-methylpentane, amine-terminated polyoxyalkylenepolyols (so-called Jeffamines) or amine-terminated polytetramethylene glycols.

The amines preferably have two primary amino groups, such as, for example, ethylenediamine, propylenediamine, 2,2-dimethyl-1,3-propanediamine, butylenediamine, pentanediamine, hexamethylenediamine, heptanediamine, octanediamine, nonanediamine, decanediamine, dodecanediamine, hexadecanediamine, tolylenediamine, xylylenediamine, diaminodiphenylmethane, diaminodicyclohexylmethane, phenylenediamine, cyclohexylenediamine, diaminodiphenyl sulfone, isophoronediamine, bis(aminomethyl)cyclohexane, 2-butyl-2-ethyl-1,5-pentamethylenediamine, 2,2,4- or 2,4,4-trimethyl-1,6-hexamethylenediamine, 2-aminopropylcyclohexylamine, 3(4)-aminomethyl-1-methylcyclohexylamine, 1,4-diamino-4-methylpentane, amine-terminated polyoxyalkylenepolyols (so-called Jeffamines) or amine-terminated polytetramethylene glycols.

Butylenediamine, pentanediamine, hexamethylenediamine, tolylenediamine, xylylenediamine, diaminodiphenylmethane, diaminodicyclohexylmethane, phenylenediamine, cyclohexylenediamine, diaminodiphenyl sulfone, isophoronediamine, bis(aminomethyl)cyclohexane, amine-terminated polyoxyalkylene-polyols (so-called Jeffamines) or amine-terminated polytetramethylene glycols are particularly preferred.

Suitable amines having three or more primary and/or secondary amino groups reactive toward a carbonate or carbamate group are, for example, tris(aminoethyl)amine, tris(aminopropyl)amine, tris(aminohexyl)amine, trisaminohexane, 4-aminomethyl-1,8-octamethylenediamine, trisaminononane, bis(aminoethyl)amine, bis(aminopropyl)amine, bis(aminobutyl)amine, bis(aminopentyl)amine, bis(aminohexyl)amine, N-(2-aminoethyl)propanediamine, melamine, oligomeric diaminodiphenylmethanes, N,N′-bis(3-aminopropyl)ethylenediamine, N,N′-bis(3-aminopropyl)butanediamine, N,N,N′,N′-tetra(3-aminopropyl)ethylenediamine, N,N,N′,N′-tetra(3-aminopropyl)butylenediamine, trifunctional or higher-functional amine-terminated polyoxyalkylenepolyols (so-called Jeffamines), trifunctional or higher-functional polyethylenimines or trifunctional or higher-functional polypropylenimines.

Preferred amines having three or more reactive primary and/or secondary amino groups are tris(aminoethyl)amine, tris(aminopropyl)amine, tris(aminohexyl)amine, trisaminohexane, 4-aminomethyl-1,8-octamethylenediamine, trisaminononane, bis(aminoethyl)amine, bis(aminopropyl)amine, bis(aminobutyl)amine, bis(aminopentyl)amine, bis(aminohexyl)amine, N-(2-aminoethyl)propanediamine, melamine or trifunctional or higher-functional amine-terminated polyoxyalkylenepolyols (so-called Jeffamines).

Amines having three or more primary amino groups, such as tris(aminoethyl)amine, tris(aminopropyl)amine, tris(aminohexyl)amine, trisaminohexane, 4-aminomethyl-1,8-octamethylenediamine, trisaminononane or trifunctional or higher-functional amine-terminated polyoxyalkylenepolyols (so-called Jeffamines) are particularly preferred.

Of course, mixtures of said amines can also be used.

In general, both amines having two primary or secondary amino groups and amines having three or more primary or secondary amino groups are used. Such amine mixtures can also be characterized by the average amine functionality, unreacted tertiary amino groups being neglected. Thus, for example, an equimolar mixture of a diamine and a triamine has an average functionality of 2.5. Those amine mixtures for which the average amine functionality is from 2.1 to 10, in particular from 2.1 to 5, are preferably reacted.

The reaction of the carbonate with the di- or polyamine to give the highly functional hyperbranched polyurea used according to the invention is effected with elimination of the alcohol or phenol bound in the carbonate. If one molecule of carbonate reacts with two amino groups, two molecules of alcohol or phenol are eliminated and a urea group is formed. If one molecule of carbonate reacts with only one amino group, a carbamate group is formed with elimination of one molecule of alcohol or phenol.

The reaction of the carbonate or of the carbonates with the amine or the amines can be effected in a solvent. In general, it is possible to use all solvents which are inert to the respective starting materials. Organic solvents, such as decane, dodecane, benzene, toluene, chlorobenzene, dichlorobenzene, xylene, dimethylformamide, dimethylacetamide or solvent naphtha, are preferably employed.

In a preferred embodiment, the reaction is carried out in the absence of a solvent, i.e. without an inert solvent. The alcohol liberated in the reaction between amine and carbonate or carbamate or the phenol liberated can be separated off by distillation, if appropriate under reduced pressure, and can thus be removed from the reaction equilibrium. This also accelerates the reaction.

For accelerating the reaction with amine and carbonate or carbamate, catalysts or catalyst mixtures can also be added. Suitable catalysts are in general compounds which catalyze the carbamate or urea formation, for example alkali metal or alkaline earth metal hydroxides, alkali metal or alkaline earth metal bicarbonates, alkali metal or alkaline earth metal carbonates, tertiary amine, ammonium compounds, organic aluminum, tin, zinc, titanium, zirconium or bismuth compounds. For example, lithium, sodium, potassium or cesium hydroxide, lithium, sodium, potassium or cesium carbonate, diazabicyclooctane (DABCO), diazabicyclononene (DBN), diazabicycloundecene (DBU), imidazoles, such as imidazole, 1-methylimidazole, 2-methylimidazole or 1,2-dimethylimidazole, titanium tetrabutylate, dibutyltin oxide, dibutyltin dilaurate, tin dioctoate, zirconium acetylacetonate or mixtures thereof may be used.

The catalyst is added in general in an amount of from 50 to 10 000, preferably from 100 to 5000, ppm by weight, based on the amount of the amine used.

The highly functional highly branched polyureas thus prepared are terminated either with amino groups or with carbamate groups after the reaction, i.e. without further modification. They are readily soluble in polar solvents, for example in water, alcohols, such as methanol, ethanol or butanol, alcohol/water mixtures, dimethylformamide, dimethylacetamide, N-methylpyrrolidone, ethylene carbonate or propylene carbonate.

In the context of the invention, a highly functional hyperbranched polyurea is understood as meaning a product which has urea groups and at least four, preferably at least six, in particular at least eight, functional groups. In principle, the number of functional groups has no upper limit, but products having a very large number of functional groups may have undesired properties, for example a high viscosity or poor solubility. The highly functional polyureas used according to the invention therefore generally have not more than 100 functional groups, preferably not more than 30 functional groups. Here, functional groups are to be understood as meaning primary, secondary or tertiary amino groups or carbamate groups. In addition, the highly functional hyperbranched polyurea may have further functional groups which do not participate in the synthesis of the hyperbranched polymer (see below). These further functional groups can be introduced by di- or polyamines which also have further functional groups in addition to primary or secondary amino groups.

The polyureas used according to the invention may comprise further functional groups. The functionalization can be effected during the reaction of the carbonate with the amine or amines, i.e. during the polycondensation reaction which results in an increase in the molecular weight, or after the end of the polycondensation reaction by subsequent functionalization of the polyureas obtained.

If components which have further functional groups in addition to amino or carbamate groups are added before or during the increase in molecular weight, a polyurea having randomly distributed further functional groups, i.e. functional groups differing from the carbamate or amino groups, is obtained.

For example, components which have hydroxyl groups, mercapto groups, tertiary amine groups, ether groups, carboxyl groups, sulfo groups, phosphonic acid groups, aryl radicals or long-chain alkyl radicals in addition to amino groups or carbamate groups can be added before or during the polycondensation.

Compounds which have hydroxyl groups and may be added for the functionalization comprise, for example, ethanolamine, N-methylethanolamine, propanolamine, isopropanolamine, butanolamine, 2-amino-1-butanol, 2-(butylamino)ethanol, 2-(cyclohexylamino)ethanol, 2-(2′-aminoethoxy)ethanol and higher alkoxylation products of ammonia, 4-hydroxypiperidine, 1-hydroxyethylpiperazine, diethanolamine, dipropanolamine, diisopropanolamine, tris(hydroxymethyl)aminomethane or tris(hydroxyethyl)aminomethane.

Components which comprise mercapto groups and may be added for the functionalization comprise, for example, cysteamine. The hyperbranched polyureas can be functionalized with tertiary amino groups, for example, by the concomitant use of N-methyldiethylenetriamine or N,N-dimethylethylenediamine. The hyperbranched polyureas can be functionalized with ether groups by the concomitant use of amine-terminated polyetherols (so-called Jeffamines). The hyperbranched polyureas can be functionalized with acid groups, for example, by the concomitant use of aminocarboxylic acids, aminosulfonic acids or aminophosphonic acids. The hyperbranched polyureas can be functionalized with long-chain alkyl radicals by the concomitant use of alkylamines or alkyl isocyanates having long-chain alkyl radicals.

Furthermore, the polyureas can also be functionalized by using small amounts of monomers which have functional groups differing from amino groups or carbamate groups. Difunctional, trifunctional or higher-functional alcohols which can be incorporated into the polyurea via carbonate or carbamate functions may be mentioned here by way of example. Thus, for example, hydrophobic properties can be achieved by adding long-chain alkanediols, alkenediols or alkynediols, while polyethylene oxide diols or triols produce hydrophilic properties in the polyurea.

Said functional groups which differ from amine, carbonate or carbamate groups and are introduced before or during the polycondensation are generally introduced in amounts of from 0.1 to 80 mol %, preferably in amounts of from 1 to 50 mol %, based on the sum of the amino, carbamate and carbonate groups.

Subsequent functionalization of highly functional, hyperbranched polyureas comprising amino groups can be achieved, for example, by adding molecules comprising acid groups, isocyanate groups, keto groups or aldehyde groups or molecules comprising activated double bonds, for example acrylic double bonds. For example, polyureas comprising acid groups can be obtained by reaction with acrylic acid or maleic acid and derivatives thereof with, if appropriate, subsequent hydrolysis.

Furthermore, highly functional hyperbranched polyureas comprising amino groups can be converted into highly functional polyurea polyols by reaction with alkylene oxides, for example ethylene oxide, propylene oxide or butylene oxide.

By salt formation with protonic acids or by quaternization of the amino functions with alkylating reagents, such as methyl halides or dialkyl sulfates, the highly functional, highly branched polyureas can be made water-soluble or water-dispersible.

In order to achieve water repellency, amine-terminated highly functional highly branched polyureas can be reacted with saturated or unsaturated long-chain carboxylic acids or derivatives thereof which are reactive toward amine groups, or with aliphatic or aromatic isocyanates.

Polyureas terminated with carbamate groups can be rendered hydrophobic by reaction with long-chain alkylamines or long-chain aliphatic monoalcohols.

### Hyperbranched Polyamides

Hyperbranched polyamides suitable for use as demulsifiers can be prepared by reacting a first monomer A₂ having at least two functional groups A with a second monomer B₃ having at least three functional groups B,
1) the functional groups A and B reacting with one another, and
2) one of the monomers A and B being an amine and the other one of the monomers A and B being a carboxylic acid or an acrylate, and
3) the molar ratio A₂:B₃ being from 1.1:1 to 20:1.

Suitable hyperbranched polyamides include hyperbranched polyamidoamines (cf. EP-A 802 215, US 2003/0069370 A1 and US 2002/0161113 A1).

Although the first monomer A₂ can also have more than two functional groups A, it is referred to here as A₂ for the sake of simplicity, and although the second monomer B₃ can also have more than three functional groups B, it is referred to here as B₃ for the sake of simplicity. All that is important is that the functionalities of A₂ and B₃ differ.

According to condition 1), the functional groups A and B react with one another. The functional groups A and B are chosen so that A does not react with A (or reacts only to an insignificant extent), and B does not react with B (or reacts only to an insignificant extent), but A reacts with B.

According to condition 2), one of the monomers A and B is an amine and the other one of the monomers A and B is a carboxylic acid.

The monomer A₂ is preferably a carboxylic acid having at least two carboxyl groups, and the monomer B₃ is an amine having at least three amino groups. Alternatively, the monomer A₂ is an amine having at least two amino groups and the monomer B₃ is a carboxylic acid having at least three carboxyl groups.

Suitable carboxylic acids usually have from 2 to 4, in particular 2 or 3, carboxyl groups, and an alkyl radical, aryl radical or arylalkyl radical having 1 to 30 carbon atoms.

For example, the following dicarboxylic acids are suitable: oxalic acid, malonic acid, succinic acid, glutaric acid, adipic acid, pimelic acid, suberic acid, azelaic acid, sebacic acid, undecane-α,ω-dicarboxylic acid, dodecane-α,ω-dicarboxylic acid, cis- and trans-cyclohexane-1,2-dicarboxylic acid, cis- and trans-cyclohexane-1,3-dicarboxylic acid, cis- and trans-cyclohexane-1,4-dicarboxylic acid, cis- and trans-cyclopentane-1,2-dicarboxylic acid and cis- and trans-cyclopentane-1,3-dicarboxylic acid, it being possible for the dicarboxylic acids to be substituted by one or more radicals selected from C₁-C₁₀-alkyl groups, C₃-C₁₂-cycloalkyl groups, alkylene groups and C₆-C₁₄-aryl groups. The following may be mentioned as examples of substituted dicarboxylic acids: 2-methylmalonic acid, 2-ethylmalonic acid, 2-phenylmalonic acid, 2-methylsuccinic acid, 2-ethylsuccinic acid, 2-phenylsuccinic acid, itaconic acid and 3,3-dimethylglutaric acid.

Ethylenically unsaturated dicarboxylic acids, such as, for example, maleic acid and fumaric acid, and aromatic dicarboxylic acids, such as, for example, phthalic acid, isophthalic acid and terephthalic acid, are also suitable.

Suitable tricarboxylic acids or tetracarboxylic acids are, for example, trimesic acid, trimellitic acid, pyromellitic acid, butanetricarboxylic acid, naphthalenetricarboxylic acid and cyclohexane-1,3,5-tricarboxylic acid.

Furthermore, mixtures of two or more of the abovementioned carboxylic acids can be used. The carboxylic acids can be used either as such or in the form of derivatives. Such derivatives are in particular
the anhydrides of said carboxylic acids, in particular in monomeric or polymeric form;
the esters of said carboxylic acids, e.g.
   mono- or dialkyl esters, preferably mono- or dimethyl esters or the corresponding mono- or diethyl esters, but also the mono- and dialkyl esters derived from higher alcohols, such as, for example, n-propanol, isopropanol, n-butanol, isobutanol, tert-butanol, n-pentanol or n-hexanol,
   mono- and divinyl esters and
   mixed esters, preferably methyl ethyl esters.

A mixture of a carboxylic acid and one or more of its derivatives, or a mixture of a plurality of different derivatives of one or more dicarboxylic acids, can also be used.

Succinic acid, glutaric acid, adipic acid, cyclohexanedicarboxylic acids, phthalic acid, isophthalic acid, terephthalic acid or the mono- or dimethyl esters thereof are particularly preferably used as the carboxylic acid. Succinic acid and adipic acid are very particularly preferred.

Suitable amines usually have from 2 to 6, in particular from 2 to 4, amino groups and an alkyl radical, aryl radical or arylalkyl radical having 1 to 30 carbon atoms.

Examples of suitable diamines are those of the formula R¹—NH—R²—NH—R³, where R¹, R² and R³, independently of one another, are hydrogen or an alkyl radical, aryl radical or arylalkyl radical having 1 to 20 carbon atoms. The alkyl radical may be linear or, in particular for R², also cyclic.

Suitable diamines are, for example, ethylenediamine, the propylenediamines, (1,2-diaminopropane and 1,3-diaminopropane), N-methylethylenediamine, piperazine, tetramethylenediamine (1,4-diaminobutane), N,N′-dimethylethylenediamine, N-ethylethylenediamine, 1,5-diaminopentane, 1,3-diamino-2,2-diethylpropane, 1,3-bis(methylamino)propane, hexamethylenediamine (1,6-diaminohexane), 1,5-diamino-2-methylpentane, 3-(propylamino)propylamine, N,N′-bis(3-aminopropyl)piperazine, N,N′-bis(3-aminopropyl)piperazine and isophoronediamine (IPDA).

Suitable triamines, tetramines or higher-functional amines are, for example, tris(2-aminoethyl)amine, tris(2-aminopropyl)amine, diethylenetriamine (DETA), triethylenetetramine (TETA), tetraethylenepentamine (TEPA), isopropylenetriamine, dipropylenetriamine and N,N′-bis(3-aminopropyl)ethylenediamine.

Aminobenzylamines and aminohydrazines having 2 or more amino groups are likewise suitable.

DETA or tris(2-aminoethyl)amine or mixtures thereof are preferably used as amines.

Mixtures of a plurality of carboxylic acids or carboxylic acid derivatives or mixtures of a plurality of amines may also be used. The functionality of the different carboxylic acids or amines may be identical or different.

In particular, if the monomer A₂ is a diamine, mixtures of dicarboxylic acids and tricarboxylic acids (or higher-functional carboxylic acids) can be used as monomer B₃, the mixture B₃ having an average functionality of at least 2.1. For example, a mixture of 50 mol % of dicarboxylic acid and 50 mol % of tricarboxylic acid has an average functionality of 2.5.

In a similar manner, if the monomer A₂ is a dicarboxylic acid, mixtures of diamines and triamines (or higher-functional amines) can be used as monomer B₃, the mixture B₃ having an average functionality of at least 2.1. This variant is particularly preferred. For example, a mixture of 50 mol % of diamine and 50 mol % of triamine has an average functionality of 2.5.

The reactivity of the functional groups A of the monomer A₂ may be identical or different. Likewise, the reactivity of the functional groups B of the monomer B₃ may be identical or different. In particular, the reactivity of the two amino groups of the monomer A₂ or of the three amino groups of the monomer B₃ may be identical or different.

In a preferred embodiment, the carboxylic acid is the difunctional monomer A₂ and the amine is the trifunctional monomer B₃, i.e. dicarboxylic acids and triamines or higher-functional amines are preferably used.

A dicarboxylic acid is particularly preferably used as a monomer A₂ and a triamine as a monomer B₃. Adipic acid is very particularly preferably used as monomer A₂ and diethylenetriamine or tris(2-aminoethyl)amine as the monomer B₃.

According to condition 3), the molar ratio A₂:B₃ is from 1.1:1 to 20:1 Accordingly, the difunctional monomer A₂ is used in a defined (not arbitrary) excess. The molar ratio A₂:B₃ is preferably from 1.1:1 to 10:1. This molar ratio is the molar ratio over all stages in the case of a two-stage or multistage reaction, as described below.

The reaction of the monomers A₂ and B₃ can be carried out in one stage by combining A₂ and B₃ in a corresponding molar ratio and reacting them directly to give the end product polyamide. In this one-stage reaction, the reactivity of the functional groups B of the monomer B₃ is preferably identical. In the one-stage reaction, the molar ratio A₂:B₃ is from 1.1:1 to 20:1, preferably from 1.1:1 to 10:1 and particularly preferably from 1.2:1 to 3:1.

Particularly preferably, the amino groups are identical and the molar ratio A₂:B₃ is from 1.2:1 to 3:1.

In another, particularly preferred embodiment, the reaction of A₂ and B₃ is preferably carried out in a plurality of stages, in particular in two stages. This multistage reaction is particularly preferred when the reactivity of the functional groups B of the monomer B₃ is different.

In a two-stage reaction, A₂ is used in a large molar excess relative to B₃ in the first stage; in particular, the molar ratio A₂:B₃ in this first stage is from 2.5:1 to 20:1, preferably from 2.5:1 to 6:1. Because of the large molar excess of A₂, a prepolymer having free (unreacted) terminal groups A forms. In many cases, a rapid increase in viscosity of the reaction mixture is observed at the end of the first stage, which can be employed for recognizing the end of the reaction.

In the second stage, the prepolymer obtained is reacted with further monomer B₃ to give the end product, the terminal groups A of the prepolymer reacting with B₃. Instead of the monomer B₃, it is also possible to use a monomer B₂ having two functional groups B (instead of three or more, as in the case of B₃).

Accordingly, in a preferred embodiment, the amino groups are different and the monomers A₂ and B₃ are reacted with one another in a molar ratio A₂:B₃ of from 2.5:1 to 20:1, with the result that a prepolymer having the functional groups A as terminal groups forms, and this prepolymer is then reacted with further monomer B₃ or with a monomer B₂ having two functional groups B.

For example, in the first stage, a triamine B₃ can be reacted with a large molar excess of dicarboxylic acid A₂ to give a prepolymer having terminal carboxyl groups, and, in the second stage, this prepolymer can be reacted with further triamine Bs or with a diamine B₂ to give the end product. The stated mixture of diamine and triamine having an average functionality of at least 2.1 is also suitable as triamine B₃.

In a similar manner—but less preferred—a tricarboxylic acid B₃ can be reacted with a large molar excess of diamine A₂ in the first stage to give a prepolymer having terminal amino groups, and, in the second stage, this prepolymer can be reacted with further tricarboxylic acid B₃ or a dicarboxylic acid B₂ to give the end product. The stated mixture of dicarboxylic acid and tricarboxylic acid having an average functionality of at least 2.1 is also suitable as tricarboxylic acid B₃.

The amount of the monomer B₃ or B₂ required in the second stage depends, inter alia, on the number of free terminal groups A in the prepolymer. This terminal group content of the prepolymer can be determined, for example, by titration of the acid number according to DIN 53402-2.

Usually, from 0.25 to 2 mol, preferably from 0.5 to 1.5 mol, of the monomer B₃ or B₂ are used per mole of terminal groups A. Preferably, about 1 mol of B₃ or B₂ per mole of terminal groups A is used, for example 1 mol of triamine or diamine per mole of terminal carboxyl groups. The monomer B₃ or B₂ can be added, for example, all at once, batchwise in a plurality of portions or continuously, for example along a linear, ascending, descending or step function.

The two stages can be carried out in a simple manner in the same reactor; isolation of the prepolymer or introduction and removal of protective groups is not required. Of course, it is also possible to use a different reactor for the second stage.

If the reaction is effected in more than two stages, the first stage (preparation of the prepolymer) and/or the second stage (reaction with B₃ or B₂) can be carried out in a plurality of part-stages.

By means of the multistage reaction, it is possible to prepare hyperbranched polyamides having relatively high molecular weights. Polymers which have defined terminal monomer units (terminal groups of the polymer branches) are obtainable by varying the molar ratios. For example, polyamides having terminal amino groups can be prepared.

By means of the two-stage reaction, it is also possible to prepare polymers having a relatively high degree of branching (DB). In the case of the polyamides obtained by one-stage reaction, the degree of branching DB is usually from 0.2 to 0.7, preferably from 0.3 to 0.6 and in particular from 0.35 to 0.55. In the case of the polyamides obtained by two-stage reaction, the degree of branching DB is usually from 0.3 to 0.8, preferably from 0.35 to 0.7 and in particular from 0.4 to 0.7.

During or after the polymerization of the monomers A₂ and B₃ to give the hyperbranched polyamide, difunctional or higher-functional monomers C acting as chain extenders can be concomitantly used. This makes it possible to control the gel point of the polymer (time when insoluble gel particles are formed as a result of crosslinking reactions, cf. for example Flory, Principles of Polymer Chemistry, Cornell University Press, 1953, pages 387-398) and to change the architecture of the macromolecule, i.e. the linkage of the monomer branches.

Accordingly, in a preferred embodiment of the process, a monomer C acting as a chain extender is concomitantly used during or after the reaction of the monomers A₂ and B₃.

For example, the abovementioned diamines or higher-functional amines which react with the carboxyl groups of different polymer branches and thus link them are suitable as chain-extending monomer C. Isophoronediamine, ethylenediamine, the propylenediamines (1,2-diaminopropane and 1,3-diaminopropane), N-methylethylenediamine, piperazine, tetramethylenediamine (1,4-diaminobutane), N,N′-dimethylethylenediamine, N-ethylethylenediamine, 1,5-diaminopentane, 1,3-diamino-2,2-diethylpropane, 1,3-bis(methylamino)propane, hexamethylenediamine (1,6-diaminohexane), 1,5-diamino-2-methylpentane, 3-(propylamino)propylamine, N,N′-bis(3-aminopropyl)piperazine, N,N′-bis(3-aminopropyl)piperazine and isophoronediamine (IPDA) are particularly suitable.

Amino acids of the general formula H₂N—R—COOH are also suitable as chain extenders C, where R is an organic radical.

The amount of the chain extenders C depends in the customary manner on the desired gel point or the desired architecture of the macromolecule. As a rule, the amount of the chain extenders C is from 0.1 to 50, preferably from 0.5 to 40 and in particular from 1 to 30% by weight, based on the sum of the monomers A₂ and B₃ used.

For the preparation of functionalized polyamides, monofunctional comonomers D are concomitantly used, it being possible to add these before, during or after the reaction of the monomers A₂ and B₃. In this way, a polymer chemically modified with the comonomer units and the functional groups thereof is obtained.

Accordingly, in a preferred embodiment of the process, a comonomer D having a functional group is concomitantly used before, during or after the reaction of the monomers A₂ and B₃, with the result that a modified polyamide forms.

Such comonomers D are, for example, saturated or unsaturated monocarboxylic acids, including fatty acids, and anhydrides or esters thereof. For example, acetic acid, propionic acid, butyric acid, valeric acid, isobutyric acid, trimethylacetic acid, caproic acid, caprylic acid, heptanoic acid, capric acid, pelargonic acid, lauric acid, myristic acid, palmitic acid, montanic acid, stearic acid, isostearic acid, nonanoic acid, 2-ethylhexanoic acid, benzoic acid and unsaturated monocarboxylic acids, such as methacrylic acid, and the anhydrides and esters, for example acrylic esters or methacrylic esters, of said monocarboxylic acids are suitable.

Suitable unsaturated fatty acids D are, for example, oleic acid, ricinoleic acid, linoleic acid, linolenic acid, erucic acid, fatty acids obtained from soybean, linseed, castor oil and sunflower.

Suitable carboxylic esters D are in particular methyl methacrylate, hydroxyethyl methacrylate and hydroxypropyl methacrylate.

Suitable comonomers D are also alcohols, including fatty alcohols, e.g. glyceryl monolaurate, glyceryl monostearate, ethylene glycol monomethyl ether, the polyethylene monomethyl ethers, benzyl alcohol, 1-dodecanol, 1-tetradecanol, 1-hexadecanol and unsaturated fatty alcohols.

Suitable comonomers D are also acrylates, in particular alkyl acrylates, such as n-butyl, isobutyl and tert-butyl acrylate, lauryl acrylate or stearyl acrylate, or hydroxyalkyl acrylates, such as hydroxyethyl acrylate, hydroxypropyl acrylate and the hydroxybutyl acrylates. The acrylates can be introduced into the polymer in a particularly simple manner by Michael addition at the amino groups of the hyperbranched polyamide.

The amount of the comonomers D depends in a customary manner on the extent to which the polymer is to be modified. As a rule, the amount of the comonomers D is from 0.5 to 40, preferably from 1 to 35, % by weight, based on the sum of the monomers A₂ and B₃ used.

Depending on the type and amount of the monomers used and on the reaction conditions, the hyperbranched polyamide may have terminal carboxyl groups (—COOH) or terminal amino groups (—NH, —NH₂) or both. The choice of the comonomer D added for the functionalization depends in a customary manner on the type and number of terminal groups with which D reacts. If terminal carboxyl groups are to be modified, preferably from 0.5 to 2.5, preferably from 0.6 to 2 and particularly preferably from 0.7 to 1.5 mole equivalents of an amine, for example of a mono- or diamine and in particular of a triamine having primary or secondary amine groups, per mole of terminal carboxyl groups are used.

If terminal amino groups are to be modified, preferably from 0.5 to 2.5, preferably from 0.6 to 2 and particularly preferably from 0.7 to 1.5 mole equivalents of a monocarboxylic acid per mole of terminal amino groups are used.

As mentioned, terminal amino groups can also be reacted with said acrylates in a Michael addition, for which purpose preferably from 0.5 to 2.5, in particular from 0.6 to 2 and particularly preferably from 0.7 to 1.5 mole equivalents of an acrylate per mole of terminal amino groups are used.

The number of free COOH groups (acid number) of the end product polyamide is as a rule from 0 to 400, preferably from 0 to 200, mg of KOH per gram of polymer and can be determined, for example, by titration according to DIN 53240-2.

The reaction of the monomer A₂ with the monomers B₃ is effected as a rule at elevated temperature, for example from 80 to 180° C., in particular from 90 to 160° C. The procedure is preferably effected under inert gas, e.g. nitrogen, or under reduced pressure, in the presence or absence of a solvent, such as water, 1,4-dioxane, dimethylformamide (DMF) or dimethylacetamide (DMAC). Solvent mixtures, for example comprising water and 1,4-dioxane, are particularly suitable. However, a solvent is not required; for example, the carboxylic acid can be initially taken and melted and the amine added to the melt. The water of reaction formed in the course of the polymerization (polycondensation) is removed, for example, under reduced pressure or, with the use of suitable solvents, such as toluene, is removed by azeotropic distillation.

If the polymerization is carried out in two stages, the end of the first stage (reaction of B₃ with large excess of A₂) can, as mentioned, often be recognized from the fact that the viscosity of the reaction mixture suddenly begins to increase rapidly. When the viscosity begins to increase, the reaction can be stopped, for example by cooling. The number of terminal groups in the prepolymer can then be determined from a sample of the mixture, for example by titration of the acid value according to DIN 53402-2. Thereafter, the amount of monomer B₃ or B₂ required according to the number of terminal groups is added in the second stage and the prepolymer is thus reacted to give the end product.

The pressure is as a rule not critical and is, for example, from 1 mbar to 100 bar absolute. If no solvent is used, the water of reaction can be removed in a simple manner by working under reduced pressure, for example from 1 to 500 mbar.

The duration of the reaction is usually from 5 minutes to 48 hours, preferably from 30 min to 24 hours and particularly preferably from 1 hour to 10 hours.

The reaction of carboxylic acid and amine can be effected in the absence or presence of catalysts. Suitable catalysts are, for example, the amidation catalysts mentioned further below.

If catalysts are concomitantly used, their amount is usually from 1 to 5000, preferably from 10 to 1000 ppm by weight, based on the sum of the monomers A₂ and B₃.

During or after the polymerization, the chain extenders C mentioned can, if desired, be added. Moreover, said comonomers D may be added before, during or after polymerization, in order chemically to modify the hyperbranched polyamide.

The reaction of the comonomers D can be catalyzed by conventional amidation catalysts, if required. Such catalysts are, for example, ammonium phosphate, triphenyl phosphite or dicyclohexylcarbodiimide. Particularly in the case of temperature-sensitive comonomers D, and in the case of methacrylates or fatty alcohols as comonomer D, the reaction can also be catalyzed by enzymes, the procedure usually being effected at from 40 to 90° C., preferably from 50 to 85° C. and in particular from 55 to 80° C. and in the presence of a free-radical inhibitor.

The inhibitor and, if appropriate, working under inert gas prevent free-radical polymerization, and also undesired crosslinking reactions of unsaturated functional groups. Such inhibitors are, for example, hydroquinone, hydroquinone monomethyl ether, phenothiazine, phenol derivatives, such as 2-tert-butyl-4-methylphenol or 6-tert-butyl-2,4-dimethylphenol, or N-oxyl compounds, such as 4-hydroxy-2,2,6,6-tetramethylpiperidin-N-oxyl (hydroxy-TEMPO) or 4-oxo-2,2,6,6-tetramethylpiperidin-N-oxyl (TEMPO), in amounts of from 50 to 2000 ppm by weight, based on the sum of the monomers A₂ and B₃.

The preparation is preferably carried out batchwise but can also be effected continuously, for example in stirred containers, tubular reactors, tower reactors or other conventional reactors, which may be equipped with static or dynamic mixers and conventional apparatuses for pressure and temperature control and for operation under inert gas.

On working without a solvent, as a rule the end product is obtained immediately and can, if required, be purified by conventional purification operations. If a solvent was concomitantly used, it can be removed from the reaction mixture after the reaction in a conventional manner, for example by distillation under reduced pressure.

The preparation is distinguished by its considerable simplicity. It permits the preparation of hyperbranched polyamides in a simple one-pot reaction. The isolation or purification of intermediates or protective groups for intermediates is not required. The process is advantageous economically since the monomers are commercially available and economical.

### Hyperbranched Polyesteramides

Hyperbranched polyesteramides suitable for use as demulsifiers can be prepared by reacting a carboxylic acid having at least two carboxyl groups with an aminoalcohol which has at least one amino group and at least two hydroxyl groups,
a) the carboxylic acid and the aminoalcohol being reacted in a molar ratio of 1.1:1 to 1.95:1 to give the end product directly, or
b) first the carboxylic acid and the aminoalcohol being reacted in a molar ratio of from 2:1 to 10:1 to give a prepolymer, and then the prepolymer being reacted with a monomer M which has at least one functional group.

The process starts from a carboxylic acid having at least two carboxyl groups (dicarboxylic acid, tricarboxylic acid or higher-functional carboxylic acid) and an aminoalcohol (alkanolamine) having at least one amino group and at least two hydroxyl groups.

Suitable carboxylic acids usually have from 2 to 4, in particular 2 or 3, carboxyl groups and an alkyl radical, aryl radical or arylalkyl radical having 1 to 30 carbon atoms. Suitable carboxylic acids are all di, tri- and tetracarboxylic acids and derivatives thereof already mentioned in relation to the hyperbranched polyamides.

Succinic acid, glutaric acid, adipic acid, o-, m- or p-cyclohexanedicarboxylic acid, phthalic acid, isophthalic acid, terephthalic acid or the dimethyl esters thereof are particularly preferably used as the carboxylic acid. Succinic acid and adipic acid are very particularly preferred.

Dialkanolamines and trialkanolamines are preferably suitable as aminoalcohols (alkanolamines) having at least one amino group and at least two hydroxyl groups. Suitable dialkanolamines are, for example, those of the formula 1

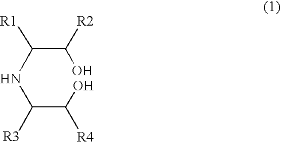

where R1, R2, R3 and R4, independently of one another, are hydrogen, C₁₋₆-alkyl, C₃₋₁₂-cycloalkyl or C₆₋₁₄-aryl (including arylalkyl).

Suitable dialkanolamines are, for example, diethanolamine, diisopropanolamine, 2-amino-1,3-propanediol, 3-amino-1,2-propanediol, 2-amino-1,3-propanediol, diisobutanolamine, bis(2-hydroxy-1-butyl)amine, diisopropanolamine, bis(2-hydroxy-1-propyl)amine and dicyclohexanolamine.

Suitable trialkanolamines are those of the formula 2

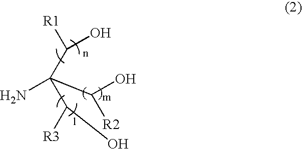

where R1, R2 and R3 have the meaning stated in formula 1 and l, m and n, independently of one another, are integers from 1 to 12. For example, tris(hydroxymethyl)aminomethane is suitable.

Diethanolamine (DEA) is preferably used as the aminoalcohol.

In a preferred process, a dicarboxylic acid is used as the carboxylic acid and an alcohol having one amino group and two hydroxyl groups is used as the aminoalcohol.

The reaction according to the invention can be carried out in one stage (this is variant a)) or two stages (this is variant b)). In the one-stage variant a), the carboxylic acid and the aminoalcohol are reacted in a molar ratio of from 1.1:1 to 1.95:1 to give the end product directly. This is in contrast to WO 00/55804 mentioned, wherein the anhydride:alkanolamine ratio is at least 2.0:1.

In variant a), the molar carboxylic acid:aminoalcohol ratio according to the invention is preferably from 1.2:1 to 1.5:1.

In the two-stage variant b), the carboxylic acid and the aminoalcohol are reacted in a molar ratio of from 2:1 to 10:1 in the first stage to give a prepolymer. In the second stage, the prepolymer is then reacted with a monomer M, M having at least one functional group.

In variant b), the molar carboxylic acid:aminoalcohol ratio according to the invention is preferably from 2.5:1 to 10:1, in particular from 2.7:1 to 5:1 and particularly preferably from 2.9:1 to 3.5:1.

A polyesteramide prepolymer having a relatively low molecular weight is obtained as a product of the first stage Owing to the large excess of carboxylic acid in the first stage, the prepolymer has free, unreacted terminal carboxyl groups, which then react in the second stage with the at least monofunctional monomer M to give the end product, the higher molecular weight polyesteramide. The concept is that the monomer M is effective as a chain end modifier.

The monomers M are preferably selected from alcohols, amines and aminoalcohols (alkanolamines).

Suitable alcohols are monoalcohols, dialcohols (diols) and higher alcohols (e.g. triols or polyols). The monoalcohols M usually have alkyl radicals, aryl radicals or arylalkyl radicals having 1 to 30, preferably 3 to 20, carbon atoms Suitable monoalcohols are, for example, n-propanol, isopropanol, n-butanol, isobutanol, tert-butanol, n-pentanol, n-hexanol, 2-ethylhexanol, lauryl alcohol, stearyl alcohol, 4-tert-butylcyclohexanol, 3,3,5-trimethylcyclohexane, 2-methyl-3-phenylpropan-1-ol and phenylglycol.

Suitable diols, triols and polyols are the diols, triols and polyols already mentioned in relation to the hyperbranched polyesters.

Monoamines, diamines, triamines or higher-functional amines (polyamines) are used as amines M. The monoamines M usually have alkyl radicals, aryl radicals or arylalkyl radicals having 1 to 30 carbon atoms; suitable monoamines are, for example, primary amines, e.g. monoalkylamines, and secondary amines, e.g. dialkylamines. Suitable primary monoamines are, for example, butylamine, pentylamine, hexylamine, heptylamine, octylamine, dodecylamine, octadecylamine, cyclohexylamine, 2-methylcyclohexylamine, 3-methylcyclohexylamine, 4-methylcyclohexylamine, benzylamine, tetrahydrofurfurylamine and furfurylamine. Suitable secondary monoamines are, for example, diethylamine, dibutylamine, di-n-propylamine and N-methylbenzylamine.

Suitable diamines, triamines and polyamines are the diamines, triamines and polyamines already mentioned in relation to the hyperbranched polyamides.

Aminoalcohols (alkanolamines) which are suitable as monomers M were mentioned further above. In addition, other monoalkanolamines and dialkanolamines are also suitable. Such monoalkanolamines are, for example, ethanolamine (i.e. monoethanolamine, MEA), isopropanolamine, mono-sec-butanolamine, 2-amino-2-methyl-1-propanol, tris(hydroxymethyl)aminomethane, 3-amino-1,2-propanediol, 1-amino-1-deoxy-D-sorbitol and 2-amino-2-ethyl-1,3-propanediol. Suitable dialkanolamines are, for example, diethanolamine (DEA), diisopropanolamine and di-sec-butanolamine.

Mixtures of said monomers M may also be used, for example mixtures of mono- and difunctional monomers M.

The amount of the monomer M depends, inter alia, on the number of terminal carboxyl groups in the prepolymer. This carboxyl group content of the prepolymer can be determined, for example, by titration of the acid number according to DIN 53402-2. Usually, from 0.6 to 2.5 mol, preferably from 0.7 to 1.7 mol and in particular from 0.7 to 1.5 mol of monomer M are used per mole of terminal carboxyl groups. The monomer M can be added, for example, all at once, batchwise in a plurality of portions or continuously, for example along a linear, ascending, descending or step function.

Both stages of variant b) can be carried out in a simple manner in the same reactor; isolation of the prepolymer or introduction and removal of protective groups are not required. Of course, a different reactor can also be used for the second stage

In variant b), both the first stage, reaction of carboxylic acid and aminoalcohol, and the second stage, reaction of the prepolymer with the monomer M, can be carried out in a plurality of part-stages, so that they are altogether three or more stages.

By means of the two-stage reaction b), hyperbranched polyesteramides having relatively high molecular weights can be prepared. By varying the molar ratios, polymers which have defined terminal monomer units (terminal groups of the polymer branches) are obtainable.

In the case of the polyesteramides obtained by one-stage reaction a), the degree of branching DB is usually from 0.2 to 0.6. In the case of polyesteramides obtained by two-stage reaction b), the degree of branching DB is usually from 0.3 to 0.8, preferably from 0.4 to 0.7 and in particular from 0.45 to 0.6.

Regardless of whether the process is carried out according to variant a) or according to variant b), the reaction is preferably terminated before the gel point of the polymer is reached (time when insoluble gel particles are formed as a result of crosslinking reactions, cf. for example Flory, Principles of Polymer Chemistry, Cornell University Press, 1953, pages 387-398), for example by allowing to cool. The reaching of the gel point is often recognizable from the sudden increase in the viscosity of the reaction mixture.

By means of the process according to the invention, it is also possible to prepare functionalized polyesteramides. Comonomers C are concomitantly used for this purpose, it being possible to add these before, during or after the reaction of carboxylic acid, aminoalcohol and, if appropriate, monomer M. In this way, a polymer chemically modified with the comonomer units and the functional groups thereof is obtained.

Accordingly, in a preferred embodiment of the process, a comonomer C is concomitantly used before, during or after the reaction of carboxylic acid, aminoalcohol and, if appropriate, monomer M, with the result that a modified polyesteramide forms. The comonomer may comprise one, two or more functional groups.

Suitable comonomers C are the saturated and unsaturated monocarboxylic acids already mentioned in relation to the hyperbranched polyamides, including fatty acids, anhydrides and esters thereof, alcohols, acrylates and the above-mentioned monofunctional or higher-functional alcohols (including diols and polyols), amines (including diamines and triamines) and aminoalcohols (alkanolamines).

The amount of the comonomers C depends in a customary manner on the extent to which the polymer is to be modified. As a rule, the amount of the comonomers C is from 0.5 to 40, preferably from 1 to 35, % by weight, based on the sum of the monomers carboxylic acid and aminoalcohol used.

The number of free OH groups (hydroxyl number) of the end product polyesteramide is as a rule from 10 to 500, preferably from 20 to 450 mg of KOH per gram of polymer and can be determined, for example, by titration according to DIN 53240-2.

The number of free COOH groups (acid number) of the end product polyesteramide is as a rule from 0 to 400, preferably from 0 to 200, mg of KOH per gram of polymer and can likewise be determined by titration according to DIN 53240-2.

The reaction of the carboxylic acid with the aminoalcohol is effected as a rule at elevated temperature, for example from 80 to 250° C., in particular from 90 to 220° C. and particularly preferably from 95 to 180° C. If the polymer is reacted with comonomers C for the purpose of modification and catalysts are used for this purpose (see further below), the reaction temperature can be adapted to the respective catalysts and the procedure can be effected as a rule at from 90 to 200° C., preferably from 100 to 190° C. and in particular from 110 to 180° C.

It is preferable to work under inert gas, e.g. nitrogen, or under reduced pressure, in the presence or absence of a solvent, such as 1,4-dioxane, dimethylformamide (DMF) or dimethylacetamide (DMAc). However, a solvent is not required; for example, the carboxylic acid can be mixed with the aminoalcohol and reacted—if appropriate in the presence of a catalyst—at elevated temperature. The water of reaction formed in the course of the polymerization (polycondensation) is removed, for example, under reduced pressure or, with the use of suitable solvents, such as toluene, by azeotropic distillation.

The end of the reaction of carboxylic acid and aminoalcohol can often be recognized from the fact that the viscosity of the reaction mixture suddenly begins to increase rapidly. When the viscosity begins to increase, the reaction can be stopped, for example by cooling. Thereafter, the number of carboxyl groups in the (pre)polymer can be determined from a sample of the mixture, for example by titration of the acid number according to DIN 53402-2, and, if appropriate, the monomer M and/or comonomer C can then be added and reacted.

The pressure is as a rule not critical and is, for example, from 1 mbar to 100 bar absolute. If no solvent is used, the water of reaction can be removed in a simple manner by working under reduced pressure, for example from 1 to 500 mbar absolute.

The duration of the reaction is usually from 5 minutes to 48 hours, preferably from 30 min to 24 hours and particularly preferably from 1 hour to 10 hours.

As mentioned, said comonomers C can be added before, during or after the polymerization, in order chemically to modify the hyperbranched polyesteramide.

In the process according to the invention, it is possible concomitantly to use a catalyst which catalyzes the reaction of the carboxylic acid with the aminoalcohol (esterification) and/or, in two-stage reaction b), also the reaction with the monomer M, and/or the reaction with the comonomer C (modification). Depending on whether the esterification, the reaction with monomer M or the modification with comonomer C is to be catalyzed, the catalyst could be added as early as the beginning or only later on.

Suitable catalysts are acidic, preferably inorganic catalysts, organometallic catalysts or enzymes.

For example, sulfuric acid, phosphoric acid, phosphonic acid, hypophosphorous acid, aluminum sulfate hydrate, alum, acidic silica gel (pH≦6, in particular ≦5) and acidic alumina may be mentioned as acidic inorganic catalysts. Furthermore, for example, aluminum compounds of the general formula Al(OR)₃ and titanates of the general formula Ti(OR)₄ can be used as acidic inorganic catalysts. Preferred acidic organometallic catalysts are, for example, selected from dialkyltin oxides R₂SnO, where R is as defined above. A particularly preferred member of acidic organometallic catalysts is di-n-butyltin oxide, which is commercially available as so-called oxo tin. For example, Fascat® 4201, a di-n-butyltin oxide from Atofina, is suitable.

Preferred acidic organic catalysts are acidic organic compounds having, for example, phosphate groups, sulfo groups, sulfate groups or phosphonic acid groups. Sulfonic acids, such as, for example, para-toluenesulfonic acid, are particularly preferred. It is also possible to use acidic ion exchangers as acidic organic catalysts, for example polystyrene resins which comprise sulfo groups and are crosslinked with about 2 mol % of divinylbenzene.

If a catalyst is used, its amount is usually from 1 to 5000 and preferably from 10 to 1000 ppm by weight, based on the sum of carboxylic acid and aminoalcohol.

Especially the reaction of the comonomers C can also be catalyzed by the abovementioned amidation catalysts, the procedure usually being effected at from 40 to 90° C., preferably from 50 to 85° C. and in particular from 55 to 80° C. and in the presence of a free-radical inhibitor.

The process according to the invention can preferably be carried out batchwise, but also continuously, for example in stirred containers, tubular reactors, tower reactors or other conventional reactors which may be equipped with static or dynamic mixers and conventional apparatuses for pressure and temperature control and for working under inert gas.

When working without a solvent, the end product is as a rule obtained directly and, if required, can be purified by conventional purification operations. If a solvent was concomitantly used, it can be removed from the reaction mixture after the reaction in a conventional manner, for example by distillation under reduced pressure.

The preparation is distinguished by its considerable simplicity. It permits the preparation of hyperbranched polyesteramides in a simple one-pot reaction. The isolation or purification of the intermediates or protective groups for intermediates are not required. The process is advantageous economically since the monomers are commercially available and economical.

For breaking the crude oil emulsions, the hyperbranched polymers used according to the invention are added to the water-in-oil or oil-in-water emulsions, preferably in dissolved form. Polymer concentrations in the solution of 10-90% by weight have proven useful. Preferably used solvents are, inter alia, water, alcohols, such as methanol, ethanol, propanol, isopropanol or butanol, ethers, such as tetrahydrofuran or dioxane, paraffinic solvents, such as hexane, cyclohexane, heptane, octane, isooctane or light gasoline fractions, or aromatic solvents, such as toluene or xylene.

In the breaking of emulsions, the polymer solutions are added to the crude oils, preferably at the probes, i.e. in the oil field. The breaking takes place at a temperature as low as that of the freshly conveyed crude oil emulsion at a speed such that the emulsion can be broken on the way to the processing plant. This broken emulsion is then separated into pure oil and water or salt water in an optionally heated separator and possibly with the aid of an electric field.

The concentration of the polymer or polymers used according to the invention, based on the oil content of the crude oil emulsion, is in general from 0.1 ppm to 5% by weight, preferably from 1 ppm to 3% by weight, particularly preferably from 2 ppm to 1% by weight and especially from 5 ppm to 0.5% by weight.

The emulsion breaker is added as a rule at 10-130° C., preferably at 40-90° C.

The hyperbranched polymers used according to the invention can be used for water-in-oil or oil-in-water emulsions comprising in general from 0.1 to 99% by weight of water or salt water. Suitable oils which can be dewatered in this manner are crude oil emulsions of any origin.

The polymers according to the invention can of course also be used as a mixture with other crude oil demulsifiers.

The invention is explained in more detail with reference to the following examples.

### EXAMPLES

### Examples 1-11

### Preparation of Hyperbranched Polycarbonates

As stated in table 1, a polyfunctional alcohol or an alcohol mixture, a dialkyl carbonate and, if appropriate, a catalyst (250 ppm, based on the mass of the alcohol) were initially taken in a four-necked flask equipped with stirrer, reflux condenser, gas inlet tube and internal thermometer, and the mixture was heated to 140° C. (in example 8 to 115° C.) and stirred for 6 h at this temperature. With progressive duration of reaction, the temperature of the reaction mixture decreased owing to the onset of evaporative cooling of the monoalcohol liberated. The reflux condenser was then exchanged for a descending condenser, an equivalent of phosphoric acid, based on the amount of catalyst, was added, the monoalcohol liberated from the dialkyl carbonate was distilled off and the temperature of the reaction mixture was slowly increased to 180° C. After the monoalcohol had been distilled off, the pressure was reduced to 8 mbar and the reaction product was degassed under a gentle stream of nitrogen.

The alcohol distilled off was collected in a cooled round-bottomed flask and weighed, and the percentage conversion, based on the theoretically possible complete conversion, was thus determined. This is reproduced in table 1.

The product mixture was then analyzed by means of gel permeation chromatography. Tetrahydrofuran or dimethylacetamide was used as the mobile phase, and polymethyl methacrylate (PMMA) as the standard.

TABLE 1
Starting materials and end products

| | | | | | Distillate, amount of | |
|---|---|---|---|---|---|---|
| | | | | | alcohol based on | Molecular weight of |
| | | | Molar | | complete | product (g/mol) |
| | | | alcohol:carbonate | | conversion | Mw |
| Example No. | Alcohol or alcohol mixture | Carbonate | ratio | Catalyst | mol % | Mn |
| 1 | PE + 5 EO, octanol, 1:1 | DEC | 1:1 | — | 70 | 5400 |
| | molar | | | | | 2400 |
| 2 | PE + 5 EO, dodecanol, | DEC | 1:1 | — | 70 | 17 800 |
| | molar 0.7:0.3 | | | | | 3600 |
| 3 | PE + 5 EO, dodecanol, | DEC | 1:1 | K₂CO₃ | 87 | 24 000 |
| | molar 0.5:5 | | | | | 4900 |
| 4 | PE + 15 EO, cis- | DEC | 1:1 | K₂CO₃ | 82 | 15 000 |
| | octadecanol, molar 0.5:0.5 | | | | | 4100 |
| 5 | TMP + 1.2 PO | DEC | 1:1 | K₂CO₃ | 90 | 2500 |
| | | | | | | 1300 |
| 6 | TMP + 12 EO | DEC | 1:1 | K₂CO₃ | 95 | 14 700 |
| | | | | | | 5700 |
| 7 | TMP + 3 EO, octadecanol, | DEC | 1:1 | K₂CO₃ | 85 | 12 400 |
| | molar 0.8:0.2 | | | | | 3000 |
| 8 | TMP + 3 EO, dodecanol, | DMC | 1:1.3 | KOH/CsOH | 85 | 39 800 |
| | molar 0.6:0.4 | | | (1:1) | | 4300 |
| 9 | TMP + 3 EO, octadecanol, | DEC | 1:1 | K₂CO₃ | 90 | 43 500 |
| | molar 0.8:0.2 | | | | | 4200 |
| 10 | TMP + 12 EO, octadecanol, | DEC | 1:1 | K₂CO₃ | 90 | 43 500 |
| | molar 0.7:0.3 | | | | | 4200 |
| 11 | Glyc + 60 EO + 16 PO, | DEC | 1:1 | K₂CO₃ | 30 | 15 000 |
| | triethanolamine, molar | | | | | 10 200 |
| | 0.7:0.3 | | | | | |

PE = Pentaerythritol
Glyc = Glycerol
TMP = Trimethylolpropane
EO = Ethylene oxide
PO = Propylene oxide
DEC = Diethyl carbonate
DMC = Dimethyl carbonate

### Example 12

### Preparation of a Hyperbranched Polyester

87.7 g of adipic acid, 155.0 g of an ethoxylated glycerol (glycerol+5 EO) and 89.1 g of glyceryl monooleate, which had been stabilized with 3000 ppm of 4-hydroxy-2,2,6,6-tetramethylpiperidine N-oxide, were initially taken in a 500 ml glass flask which was equipped with a stirrer, internal thermometer, gas inlet tube, reflux condenser and vacuum connection with a cold trap. 7.0 g of the enzyme Novozym® 435 (from Novozymes) were added and the mixture was heated with the aid of an oil bath to an internal temperature of 70° C. A reduced pressure of 80 mbar was applied in order to separate off water formed in the reaction. The reaction mixture was kept at the stated temperature and the stated pressure for 40 hours. After cooling, the hyperbranched polyester was obtained as a clear, viscous liquid having an acid number of 8 mg KOH/g. The product was dissolved in acetone and filtered, and the filtrate was freed from the solvent in a rotary evaporator at 80 mbar and 40° C. The molecular weight of the polymer was determined by gel permeation chromatography against a PMMA standard as Mn=2900 g/mol and Mw=20 300 g/mol.

### Example 13

### Preparation of a Hyperbranched Polyester

700 g of adipic acid, 374.9 g of glycerol and 257.6 g of glyceryl monostearate were initially taken in a 2 l glass flask which was equipped with a stirrer, internal thermometer, gas inlet tube, reflux condenser with vacuum connection and cold trap. The mixture was heated with the aid of an oil bath to an internal temperature of 150° C., 0.66 g of dibutyltin dilaurate was added and the resulting water of reaction was distilled off, the internal temperature slowly being increased to 180° C. After 120 g of water had been distilled off, a reduced pressure of 80 mbar was applied and a further 39 g of water were distilled off. After cooling, the hyperbranched polyester was obtained as a viscous liquid. The molecular weight of the polymer was determined by gel permeation chromatography against a PMMA standard as Mn=2100 g/mol and Mw=32 000 g/mol.

### Example 14

350 g of adipic acid, 187.5 g of glycerol and 97.2 g of glyceryl monostearate were initially taken in a 1 l glass flask which was equipped with a stirrer, internal thermometer, gas inlet tube, reflux condenser with vacuum connection and cold trap. The mixture was heated with the aid of an oil bath to an internal temperature of 150° C., 0.4 g of dibutyltin dilaurate was added and the resulting water of reaction was distilled off, the internal temperature slowly being increased to 180° C. After 56 g of water had been distilled off, a reduced pressure of 80 mbar was applied and a further 5 g of water were distilled off. After cooling, the hyperbranched polyester was obtained as a viscous liquid. The molecular weight of the polymer was determined by gel permeation chromatography against a PMMA standard as Mn=800 g/mol and Mw=5900 g/mol.

### Example 15

### Subsequent Modification of a Hyperbranched Polycarbonate, Complete Conversion of the OH Groups with Octadecyl Isocyanate

450 g of the polymer from example 5 were initially taken in a four-necked flask equipped with a stirrer, heatable dropping funnel, gas inlet tube and internal thermometer and were heated to 100° C. with blanketing with nitrogen. 1140 g of octadecyl isocyanate heated to 50° C. were then added dropwise in the course of 60 min. After the addition of the isocyanate, the mixture was heated to 120° C. and stirred for 7 h at this temperature. The product was then cooled to room temperature. The melting point of the product was 49.4° C., measured by means of differential scanning calorimetry.

### Example 16

### Subsequent Modification of a Hyperbranched Polycarbonate, 30% Conversion of the OH Groups with Octadecyl Isocyanate

450 g of the polymer from example 5 (table 1) were initially taken in a four-necked flask equipped with a stirrer, heatable dropping funnel, gas inlet tube and internal thermometer and were heated to 100° C. with blanketing with nitrogen. 342 g of octadecyl isocyanate heated to 50° C. were then added dropwise in the course of 60 min. After the addition of the isocyanate, the mixture was heated to 120° C. and stirred for 7 h at this temperature. The product was then cooled to room temperature. The melting point of the product was 40.9° C., measured by means of differential scanning calorimetry.

### Example 17

### Testing of the Suitability of the Hyperbranched Polymers as a Demulsifier by Measurement of Water Separation from a Crude Oil Emulsion

5 g of the hyperbranched polymer to be tested were weighed into a 100 ml graduated flask, the latter was made up to the graduation mark with a 3:1 xylene/isopropanol mixture (based on volume) and the hyperbranched polymer was dissolved therein by shaking.

A crude oil emulsion from Wintershall AG, Emlichheim, probe 87, having a water content of 55% by volume, was heated to a temperature of 52° C. for about 2 h in a container which was not firmly closed in a water bath.

The crude oil emulsion was homogenized for about 30 sec by shaking and 100 ml portions of the oil emulsion were introduced into 100 ml shaking cylinders. The shaking cylinders filled with oil were placed in the water bath.

Using an Eppendorf pipette, in each case 50 μl of the 5% strength by weight solution of the polymer to be tested were metered into a shaking cylinder with crude oil emulsion and the cylinder was closed with the glass stopper. Thereafter, the shaking cylinder was removed from the water bath, shaken 60 times and relaxed. The shaking cylinder was then placed back into the water bath and the timer was started. The volume of the water now separating off was read after 5, 10, 15, 30, 60, 120 and 240 min. The results are shown in table 2.

TABLE 2

| Polymer | Water separation in ml | | | | | | |
|---|---|---|---|---|---|---|---|
| from | 5 | 10 | 15 | 30 | 60 | 120 | 240 |
| example | min | min | min | min | min | min | min |
| 1 | 0 | 1 | 4 | 8 | 13 | 28 | 44 |
| 2 | 0 | 1 | 2 | 8 | 15 | 30 | 48 |
| 3 | 0 | 1 | 2 | 5 | 23 | 38 | 44 |
| 4 | 0 | 1 | 2 | 5 | 15 | 36 | 38 |
| 6 | 0 | 1 | 2 | 6 | 16 | 34 | 48 |
| 7 | 1 | 2 | 3 | 5 | 15 | 50 | 55 |
| 8 | 1 | 2 | 4 | 10 | 25 | 52 | 55 |
| 9 | 2 | 4 | 6 | 10 | 23 | 43 | 55 |
| 10 | 2 | 5 | 10 | 17 | 27 | 48 | 55 |
| 11 | 0 | 0 | 1 | 2 | 5 | 10 | 52 |
| 12 | 0 | 0 | 2 | 5 | 13 | 47 | 55 |
| 13 | 1 | 2 | 4 | 8 | 16 | 40 | 54 |
| 14 | 0 | 1 | 4 | 8 | 14 | 34 | 48 |

1-7. (canceled)

8. A process for breaking crude oil emulsions comprising (1) adding to said crude oil emulsion, which comprises oil and water or oil and salt water, a non-dendrimeric, highly functional, hyperbranched polycarbonate as a demulsifier, wherein said polycarbonate is obtained by
a) reacting at least one organic carbonate (A) of the general formula RO(CO)OR with at least one aliphatic alcohol (B) having at least three OH groups and which is selected from trifunctional or higher-functional polyetherols based on trifunctional or higher-functional alcohols and ethylene oxide, propylene oxide, or butylene oxide, optionally in a mixture with one or more difunctional alcohols (B′), with the proviso that the average OH functionality of all alcohols used is greater than 2, wherein said reaction results in the elimination of alcohols ROH to give one or more condensation products (K), wherein R, in each case independently of one another, is a straight-chain or branched aliphatic, araliphatic, or aromatic hydrocarbon radical having up to 20 carbon atoms; and
b) intermolecularly reacting said one or more condensation products (K) to give a highly functional, hyperbranched polycarbonate,
wherein the ratio of the OH groups to the carbonates in the reaction mixture is chosen so that the condensates (K) have on average either one carbonate group and more than one OH group or one OH group and more than one carbonate group; and
(2) separating the broken emulsion into oil and water or oil and salt water.

9. The process of claim 8, wherein said polycarbonate has from 8 to 30 terminal or side carbonate groups and/or OH groups.

10. The process of claim 8, wherein the degree of branching of said polycarbonate is from 30 to 80%.

11. The process of claim 8, wherein the weight average molecular weight of said polycarbonates is from 1,000 to 500,000 g/mol.

12. A process of breaking crude oil emulsions comprising (1) adding to said crude oil emulsion, which comprises oil and water or oil and salt water, a non-dendrimeric, highly functional, hyperbranched polyester added as a demulsifier obtained by reacting at least one aliphatic dicarboxylic acid (A₂) or derivatives thereof with glyceryl monooleate or glyceryl monostearate (B₂) and at least one at least trifunctional alcohol (Cₓ) selected from glycerol, diglycerol, triglycerol, trimethylolethane, trimethylolpropane, 1,2,4-butanetriol, pentaerythritol, tris(hydroxyethyl)isocyanurate or polyetherols thereof based on ethylene oxide and/or propylene oxide, wherein the ratio of the reactive groups in the reaction mixture are chosen so that a molar ratio of OH groups to carboxyl groups or derivatives thereof is from 5:1 to 1:5, and wherein the at least one dicarboxylic acid is selected from the group consisting of oxalic acid, malonic acid, succinic acid, lactic acid, tartaric acid, adipic acid, stearic acid, oleic acid, linoleic acid, and linolenic acid and (2) separating the broken emulsion into oil and water or oil and salt water.

13. The process of claim 12, wherein the degree of branching of said polyesters is from 30 to 80%.

14. The process of claim 12, wherein the weight average molecular weight of said polyesters is from 1,000 to 500,000 g/mol.
